(19) United States
(12) Patent Application Publication
(10) Pub. No.: US 2014/0116069 A1
(43) Pub. Date: May 1, 2014

(54) METHODS AND SYSTEMS FOR STORING AND TRANSPORTING GASES

(71) Applicant: Charles Matar, River Vale, NJ (US)

(72) Inventors: Edward R. Peterson, Pearland, TX (US); Thomas A. Rolfe, Dallas, TX (US)

(73) Assignee: Charles Matar, River Vale, NJ (US)

(21) Appl. No.: 14/147,669

(22) Filed: Jan. 6, 2014

Related U.S. Application Data
(62) Division of application No. 13/162,405, filed on Jun. 16, 2011.
(60) Provisional application No. 61/366,443, filed on Jul. 21, 2010.
(60) Provisional application No. 61/366,446, filed on Jul. 21, 2010.

(51) Int. Cl. F17C 7/04

(52) U.S. Cl. CPC F17C 7/04
USPC 62/50.2

(57) ABSTRACT

A method and system of storing and transporting valuable gases comprising mixing the gases with liquid natural gas to form a mixture. The mixture is transported in vessel configured for cooling the mixture by boiling a portion of liquid natural gas. The transportation vessel is further configured to be cooled in the absence of valuable gases by a remaining portion of liquid natural gas. The method further comprises recycling liquid natural gas through the vessel for pre-cooling the vessel prior to loading the mixture of valuable gases and liquid natural gas.

### CROSS REFERENCE TO RELATED APPLICATIONS

This application is a divisional of U.S. application Ser. No. 13/162,405 filed on Jun. 16, 2011, now pending, which claims the benefit under 35 U.S.C. §119(e) of U.S. Provisional Patent Application No. 61/366,446 filed Jul. 21, 2010 and 61/366,443 filed Jul. 21, 2010, the entire contents of each of which are hereby incorporated herein by reference thereto.

### BACKGROUND OF THE INVENTION

1. Field of the Invention

The present invention generally relates to storing and transporting light hydrocarbons. More particularly, the present invention relates to utilizing liquefied natural gas for storing and transporting light hydrocarbons.

2. Description of Related Art

Liquefied natural gas (LNG) transport and storage vessels are loaded with liquid natural gas that is maintained at or below −260° F. (−162° C.). During transportation, the temperature difference in magnitude between the environment and the cargo is generally between 290° F. (143° C.) and 360° F. (182° C.), though it may be higher or lower depending on ambient conditions, and, as such, the environment heats the LNG vessels. Additionally, if LNG storage and transport vessel temperature increases above the boiling point of the LNG, LNG will vaporize. Without being limited by theory, vaporization lowers the temperature of the vessel and in certain instances, the entire vehicle for carrying the vessel. When the temperature of the transport and storage vessel remains at or below the boiling point of the LNG, the LNG maintains its liquid state and the vessel maintains a constant temperature.

Ordinarily, LNG is fully off-loaded at the receiving port to take full advantage of the value of the cargo. Although in some instances, the vehicle and/or vessel may retain a partial pressure or partial load of LNG to cool the vessel and/or maintain the transport vessel temperature. On the return trip, the vessel is heated by the environment, as described previously, vaporizing the partial load of LNG.

Each LNG transport vehicle vessel produces boil-off gas, which is due to the vaporization of LNG during operation. The boil-off rate depends upon the environment and weather conditions, but can be monitored. Boil-off is minimized by better insulation around the vessel and reduced weight of the vehicle. Additionally, the boil-off is often used as fuel for the vehicle, but it can also be re-refrigerated to the liquid form. Refrigeration equipment is bulky, heavy, and expensive and suffers from poor overall energy efficiency. As a result, the vessel increases in temperature, closer to ambient or environmental temperatures during long transits between loading and off-loading. The increased temperature of the vessel results in increased time during the loading operation that must be spent cooling the storage container to the temperature that allows LNG to remain liquid if the ship was returned. This cooling time is extended if the vehicle and vessel return without a sufficient partial load of LNG.

In certain instances, during loading and pressurization of the vessel, it is cooled with LNG such that the boiled or vaporized natural gas (NG) is vented or flared to atmosphere. Alternatively, the NG is recovered, re-refrigerated, and re-circulated into the vessel. However, the time that it takes to cool the vessel to a temperature suitable for maintaining the liquid phase of the natural gas, increases the time for turn around between loading operations. The delay in this reloading caused by this vessel cooling time results in increased costs, and potential missed market opportunities. Further, refrigeration equipment is bulky, heavy, and expensive and suffers from poor overall energy efficiency.

LNG production consists of several steps that involve processing, handling, transporting and distribution of natural hydrocarbons and related materials. A standard LNG production plant may include the following units: feed handling and treating, liquefaction, refrigeration, fractionation, LNG storage, loading area and equipment, utilities, miscellaneous storage, and flare. Transportation can include large ships, generally spherical or membrane type, as well as specially designed rail cars and trucks. Ship receiving terminals collect gas or liquid for the ships. At or near the receiving terminal there are units for: gasification, pressurization, odorization, and liquid storage. At each level of processing there may be equipment for returning vapors, often referred to as blow-off or boil-off, to the liquid state.

The feed to an LNG plant often requires treatment prior to liquefaction. These steps depend upon the quality of the feed. Various treatment steps may include: liquid slug removal, condensate stabilization, acid gas removal, water removal, nitrogen removal, mercury removal, and propane and heavier gas (e.g., liquefied petroleum gas, LPG) removal, without limitation. For an LNG plant, components such as LPG, condensate and hydrocarbon liquids may have low value as saleable materials or may be more useful as fuels. Additional units/operations may include acid gas recovery and conversion, fractionation, multi-level refrigeration, refrigerant(s) storage and product loading to ship.

The LNG production facility may utilize one or more of the following utility unit operations: electrical power generation, fuel gas, liquid fuel storage, air separation, sea water storage and distribution, fresh water storage and distribution, and steam production and distribution.

Natural gas can be processed into other materials by thermal or chemical means. Methane and other hydrocarbons can be converted to acetylene, ethylene, propylene, vinyl acetylene, butylenes by thermal processes. When these thermal processes are accompanied with combustion, of which partial oxidation is an example, additional products may include carbon monoxide, carbon dioxide, hydrogen and water and other known constituents, without limitation. Further technologies such as pyrolysis, steam cracking, plasma processing, and steam reforming can form many or all of these compounds starting with hydrocarbons that are constituents of natural gas and/or oil products.

A process that utilizes pyrolysis to convert light hydrocarbons to other chemicals or to fuel products, gasoline, gasoline blendstock, and jet fuel, establishes a Gas to Multiple Product process (GTX). Such a process may utilize: oxygen and nitrogen from an air separation unit, an acid gas recovery unit, mercury removal, electrical power and low level refrigeration for product stabilization. In instances, the process includes pyrolysis to form acetylene and vinyl acetylene. The acetylene is hydrogenated to ethylene and the vinyl acetylene is hydrogenated to propylene. Further, the process optionally converts the acetylenic compounds to ethylene and propylene, without limitation. Byproducts of the hydrocarbon conversion process may include carbon dioxide, water, hydrogen, fine particulate carbon, nitrogen, and light gases including ethane and propane.

Therefore, there is a need to further develop methods and systems for storing and transporting gases (e.g., light hydrocarbons) in a more efficient and economical way.

### SUMMARY

Herein disclosed is a process for converting natural gas to hydrocarbon products comprising: (a) processing natural gas to form a first gas stream by at least one process chosen from the group consisting of partial oxidation, thermal cracking, plasma cracking, and combinations thereof, wherein said first gas stream comprises a natural gas product selected from the group consisting of acetylene, ethylene, propylene, gasoline blend-stock, gasoline, jet fuel, diesel, aromatic hydrocarbon compounds, and combinations thereof; (b) producing liquefied natural gas (LNG) from natural gas; (c) blending at least a portion of the LNG with the first gas stream; and (d) forming a transportable and storable mixture.

In some cases, forming a transportable and storable mixture comprises forming a continuous liquid phase mixture. In some cases, the method further comprises returning a portion of the produced LNG to (a). In some cases, (a) further comprises removing at least one contaminant selected from the group consisting of sulfur, mercury, heavy metals, nitrogen, carbon dioxide, sulfur containing compounds, mercury containing compounds, solid particulate matter, water, and combinations thereof. In some cases, (a) further comprises manufacturing ethylene and separating ethylene from the first gas stream. In some cases, the method further comprises utilizing the separated ethylene in (b) as a refrigerant. In some cases, (a) or (b) or both further comprise receiving an auxiliary gas stream from an air separation unit (ASU), wherein the auxiliary gas stream comprises at least one gas selected from the group consisting of air, oxygen, nitrogen, argon, and combinations thereof.

In some case, the method further comprises receiving a portion of oxygen from the ASU for (a); and receiving at least a portion of nitrogen, argon, and air from the ASU for both (a) and (b). In some case, the method further comprises receiving at least a portion of nitrogen, argon, and air from the ASU for (a); and receiving at least a portion of oxygen from the ASU for both (a) and (b). In some cases, (b) further comprises receiving energy from a pressure differential of inlet reservoir gas through a turbo expander; and directing at least a portion of the energy to compress a high value gas (HVG) during (a). In some cases, directing at least a portion of the energy to compress HVG further comprises: passing the compressed HVG through a turbo expander; and lowering the temperature of the HVG. In some cases, lowering the temperature of the HVG further comprises processing the HVG, wherein the HVG is liquefied, solidified, or prepared for blending with the LNG for storage or transport.

In some cases, (a) further comprises producing a liquid fuel. In some cases, the method further comprises providing the liquid fuel to power an action or equipment, wherein said action or equipment is selected from the group consisting of vehicular transport, localized power generation, mobile power generation, fluid transport, refrigeration systems, compressors, expanders, and combinations thereof. In some cases, (a) further comprises: producing a byproduct combustible gas stream comprising at least one gas component selected from the group consisting of methane, carbon monoxide, carbon dioxide, hydrogen, ethylene, water, and combinations thereof; and conveying the byproduct combustible gas stream to a power generation unit for producing liquefied natural gas (LNG) from natural gas. In some cases, conveying the byproduct combustible gas stream to a power generation unit further comprises: directing the power produced at the power generation unit to (a) for an operation chosen from the group consisting of compression, pumping, blending, separation, operating motors, operating control equipment, and combinations thereof.

In some cases, (a) further comprises producing a carbon dioxide stream; directing the carbon dioxide stream to a natural gas reservoir for stimulating the reservoir; and utilizing the natural gas from the reservoir in (b). In some cases, the method further comprises producing a fire suppression stream comprising carbon dioxide. In some cases, (a) further comprises: separating acetylene from the first gas stream; and forming a welding gas stream comprising acetylene. In some cases, producing liquefied natural gas (LNG) further comprises producing additional hydrocarbon components selected from the group consisting of ethane, propane, butane, and combinations thereof. In some cases, producing additional hydrocarbon components further comprises separating the additional hydrocarbon components from methane. In some cases, the method further comprises utilizing the additional hydrocarbon components for (a).

In some cases, separating the additional hydrocarbon components from methane further comprises separating ethane from the additional hydrocarbon components. In some cases, the method further comprises conveying the transportable and storable mixture to a LNG transportation vessel. In some cases, conveying the transportable and storable mixture to a LNG transportation vessel further comprises providing a vessel capable of transporting blends of LNG with natural gas products. In some cases, conveying the transportable and storable mixture further comprises thermal regulation. In some cases, the method further comprises conveying the first gas stream and the LNG to the LNG transportation vessel separately, wherein the LNG transportation vessel is capable of transporting the first gas stream and the LNG separately. In some cases, the LNG and the first gas stream are stored in adjacent compartments of the LNG transportation vessel and the adjacent compartments share at least a portion of one wall for heat transfer. In some cases, the vessel that contains the first gas stream is substantially encompassed by the compartment that contains the LNG.

In some cases, the method further comprises: heating the transportable and storable mixture; vaporizing a portion of the mixture to form a boil-off gas, wherein the vaporized portion has a different molar composition from the transportable and storable mixture. In some cases, the method further comprises cooling the boil-off gas to recover a condensed liquid. In some cases, recovering the condensed liquid further comprises at least one process selected from the group consisting of refrigeration, heat exchange, cryogenic separation, selective absorption, adsorption, phase separation, and combinations thereof.

In some cases, the method further comprises: introducing the transportable and storable mixture to a vessel; changing the pressure of the vessel; and vaporizing at least a portion of transportable and storable mixture to form a boil-off gas, wherein the boil-off gas have a different molar composition than the transportable and storable mixture. In some case, the boil-off gas is cooled and at least a portion thereof is recovered as condensed liquid. In some cases, recovering the condensed liquid further comprises utilizing the boil-off gas in a process selected from the group consisting of energy generation by combustion, cooling another medium, disposal, flaring, venting, and combinations thereof. In some cases, recovering the condensed liquid further comprises: returning at least a first portion of the condensed liquid to the vessel; and lowering the temperature of the vessel, wherein lowering the temperature further lowers the vapor pressure of the vessel.

In some cases, the method further comprises transporting the transportable and storable mixture to a different location; and separating the mixture to form an LNG stream and a second gas stream comprising a natural gas product selected from the group consisting of acetylene, ethylene, propylene, gasoline blend-stock, gasoline, jet fuel, diesel, aromatic hydrocarbon compounds, and combinations thereof.

In some cases, separating the mixture comprises a process selected from the group consisting of cryogenic separation, cryogenic distillation, distillation, crystallization, selective absorption, selective adsorption, osmosis, reverse osmosis, and combinations thereof. In some cases, separating the mixture comprises directing the mixture to a separation facility located in a place selected from the group consisting of in, on, near a natural or man-made body of water, on land, and combinations thereof. In some cases, the separation facility further comprises a facility selected from the group consisting of blend transport vessels, free floating structures, ships, barges, platforms, moored vessels, anchored structures, anchored ships, anchored barges, anchored platforms, and combinations thereof. In some cases, the separation facility is at least partially on land. In some cases, the different location comprises a receiver configured to maintain the mixture in a state selected from the group consisting of liquids, cryogenic liquids, slurries, and combinations thereof. In some cases, the different location comprises a facility configured for storing, processing, and distributing LNG. In some cases, the different location comprises a facility configured for storing, processing, and distributing the second gas stream.

In some cases, wherein separating the mixture to form an LNG stream and a second gas stream further comprises: heating the mixture to gasify at least a portion of the mixture, wherein heat is provided by a source selected from the group consisting of integral heated equipment, integral fired equipment, remote heated equipment, ambient heat from the air, fresh water, sea water, earth, combustion heat from engines, exhaust from combustion engines, compressors, motorized equipment, electrically powered equipment, and combinations thereof.

In some cases, the different location further comprises a secondary processing unit selected from the group consisting of an air separation unit, an ethylene/ethane separation plant, a differential boil-off re-liquefaction facility, a dry-ice processor, a crystallization unit, a cryogenic cooling unit, and combinations thereof. In some cases, the different location further comprises a cryogenic separation tower (CST) for separating the second gas stream from LNG. In some cases, the CST is configured to be operated as a heat sink and the CST re-boiler is configured to be operated as a heat source; wherein the heat source and heat sink are used to generate electricity.

In some cases, the method further comprises converting the second gas stream into a phase selected from the group consisting of liquids, gases, supercritical fluids, and combinations thereof, and pressurizing said phase for distribution. In some cases, the method further comprises distributing said phase utilizing an insulated pipe. In some cases, the method further comprises removing a contaminant selected from the group consisting of sulfur, mercury, oxygen, oils, waxes, sand, soil, debris, particulates, and combinations thereof; and wherein removing the contaminant utilizes a unit selected from the group consisting of inlet filter separators, mist extractors, carbon filters, mol sieves, selective absorbents, and combinations thereof.

In some cases, the method further comprises introducing the mixture to a vessel for storage; removing vapor produced during storage; re-liquefying the vapor produced during storage; and conveying the re-liquefied vapor to a CST. In some cases, removing vapor produced during storage further comprises: flashing the transportable and storable mixture in a separator; and producing a lean vapor and an enriched liquid, wherein the lean vapor and enriched liquid are fed to the CST. In some cases, the method further comprises heating and gasifying the mixture, wherein said heating is partially provided by the condensation of overhead gases in the CST overhead condenser. In some cases, the method further comprises collecting the CST bottoms, wherein the CST bottoms comprise ethane.

In some cases, the method further comprises separating ethane from the remaining components of the CST bottoms using a method selected from the group of consisting of cryogenic separation, cryogenic distillation, distillation, crystallization, selective absorption, selective adsorption, osmosis, reverse osmosis, and combinations thereof.

In some cases, the method further comprises substantially removing ethane from the LNG; and conveying ethane to (a).

Also disclosed herein is a method for transporting gases, comprising: mixing a first gas stream with a liquid natural gas stream to form a liquid mixture at a first location; transporting the liquid mixture in a vessel to a second location; removing the mixture from the vessel; separating the mixture to form a product gas and liquid natural gas; and recycling the liquid natural gas to the vessel.

In some cases, the first gas stream comprises a high value gas. In some cases, the first gas stream comprises at least one gas chosen from the group consisting of ethylene, acetylene, propylene noble gases, hydrogen sulfide, ammonia, phosgene, methyl-ethyl ether, tri-fluorobromoethane, chlorotrifluoromethane, chlorodifluoromethane, di-chloromonofluorormethane, carbon dioxide, carbon monoxide, butene, dibutene, vinyl acetylene, methyl acetylene, water, hydrogen, and combinations thereof. In some cases, the first gas stream comprises a liquefied gas. In some cases, the liquefied gas is in greater proportion than the liquid natural gas in the liquid mixture.

In some cases, mixing the first gas stream with the liquid natural gas further comprises reducing the temperature of the mixture to below the boiling temperature of the liquid natural gas and the liquefied gas in the first gas stream. In some cases, mixing the first gas stream with the liquid natural gas stream further comprises allowing the liquid natural gas to boil. In some cases, transporting the mixture further comprises removing a portion of the mixture for at least one process chosen from the group consisting of fueling a refrigeration system, fueling a transport vehicle, and combination thereof.

Further disclosed herein is a method for transporting gases, comprising mixing a first gas with liquid natural gas at a first location, to form a first liquid-gas mixture; loading a first vessel with the first liquid-gas mixture at the first location; cooling the first vessel by boiling the liquid natural gas; transporting the first vessel to a second location; off-loading the mixture at the second location; separating the mixture into the first gas and the liquid natural gas; and recycling the liquid natural gas to the first vessel.

In some cases, the first gas comprises a component with a market value higher than the market value of liquid natural gas. In some cases, the first gas comprises at least one component chosen from the group consisting of ethylene, acetylene, propylene noble gases, hydrogen sulfide, ammonia, phosgene, methyl-ethyl ether, tri-fluorobromoethane, chlorotrifluoromethane, chlorodifluoromethane, di-chloromonofluorormethane, carbon dioxide, carbon monoxide, butene, dibutene, vinyl acetylene, methyl acetylene, water, hydrogen, and combinations thereof.

In some cases, mixing the first gas with liquid natural gas further comprises liquefying the first gas. In some cases, recycling the liquid natural gas to the vessel further comprises pre-cooling the vessel. In some cases, the method further comprises mixing a second gas with the liquid natural gas, to form a second liquid-gas mixture; loading a second vessel with the second liquid-gas mixture at the second location; cooling the second vessel by boiling the liquid natural gas; transporting the second vessel to a third location; off-loading the mixture at the third location; separating the mixture into the second gas and the liquid natural gas; and recycling the liquid natural gas to the second vessel.

In some cases, the second vessel is the first vessel and the third location is the first location. In some cases, the third location comprises a location for selling the second gas. In some cases, recycling the liquid natural gas to the second vessel further comprises cooling the second vessel. In some cases, separating the mixture further comprises separating the liquid natural gas cryogenically; directing the liquid natural gas to a condenser; and directing the liquid natural gas to the second vessel. In some cases, directing the natural gas to the second vessel further comprises cooling the second vessel. In some cases, cooling the vessel further comprises pre-loading the second vessel with liquid nitrogen.

Disclosed herein is a process for converting natural gas to hydrocarbon products comprising: processing natural gas to natural gas products in a first facility by at least one process chosen from the group consisting of partial oxidation, thermal cracking, plasma cracking, and combinations thereof, to form a first gas stream; directing the first gas stream comprising a natural gas product comprising a component selected from the group consisting of acetylene, ethylene, propylene, gasoline blend-stock, gasoline, jet fuel, diesel, aromatic hydrocarbon compounds, and combinations thereof, to an adjacent facility; producing liquefied natural gas (LNG) from natural gas at the adjacent facility; blending at least a portion of the liquefied natural gas with the first gas stream; and forming a transportable and storable mixture.

In some cases, forming a transportable and storable mixture comprises forming a continuous liquid phase mixture. In some cases, blending a least a portion of the liquefied natural gas further comprises mixing a portion of the excess capacity of the LNG facility with the first gas stream. In some cases, directing a first gas stream further comprises returning a portion of the adjacent facility LNG production to the first facility, wherein the first facility is a GTX facility.

In some cases, the natural gas conversion facility feed further comprises removing at least one contaminant selected from the group consisting of sulfur, mercury, heavy metals, nitrogen, carbon dioxide, sulfur containing compounds, mercury containing compounds, solid particulate matter, water, and combinations thereof, by reduced gas purification.

In some cases, processing the natural gas further comprises treating and purifying the natural gas that is to be included in the first gas stream, and liquefying into LNG in the first diverted to the natural gas conversion process. In some cases, treating and purifying the natural gas further comprises removing a contaminant selected from the group consisting of sulfur, mercury, heavy metals, nitrogen, carbon dioxide, sulfur containing compounds, mercury containing compounds, solid particulate matter, water, and combinations thereof.

In some cases, processing natural gas to natural gas products further comprises manufacturing ethylene; separating ethylene from the first gas stream; and directing the ethylene to LNG liquefaction facility as a refrigerant. In some cases, the steps of processing natural gas to natural gas products and producing liquefied natural gas (LNG) from natural gas further comprise receiving a second gas stream from an air separation unit (ASU) operation, and wherein the second gas stream comprises at least one gas selected from the group consisting of air, oxygen, nitrogen, argon, and combinations thereof.

In some cases, receiving a second gas stream from an air separation unit (ASU) operation further comprises: receiving a portion of oxygen for processing natural gas to natural gas products; and receiving at least a portion of the nitrogen, argon, and air, for both processing natural gas to natural gas products and producing liquefied natural gas (LNG) from natural gas. In some cases, receiving a second gas stream from an air separation unit (ASU) operation further comprises: receiving at least a portion of the nitrogen, argon, and air for processing natural gas to natural gas products; and receiving at least a portion of the oxygen, for both processing natural gas to natural gas products and producing liquefied natural gas (LNG) from natural gas.

In some cases, producing liquefied natural gas (LNG) from natural gas further comprises: receiving energy from a pressure differential of inlet reservoir gas through a turbo expander; and directing at least a portion of the energy to compress HVG during processing natural gas to natural gas products. In some cases, directing at least a portion of the energy to compress HVG further comprises: passing the compressed HVG through a turbo expander; and lowering the temperature of the HVG.

In some cases, lowering the temperature of the HVG further comprises processing the HVG, wherein the HVG is liquefied, solidified, or prepared for blending with the LNG for storage or transport. In some cases, processing natural gas to natural gas products further comprises producing a liquid fuel. In some cases, producing a liquid fuel further comprises supplying the liquid fuel for components used during processing natural gas to natural gas products, wherein the components include at least one component selected from the group consisting of vehicular transport, localized power generation, mobile power generation, fluid transport (pumps), refrigeration systems, compressors, expanders, and combinations thereof.

In some cases, processing natural gas to natural gas products further comprises: producing a byproduct combustible gas stream comprising at least one gas component selected from the group consisting of methane, carbon monoxide, carbon dioxide, hydrogen, ethylene, water, and combinations thereof; and conveying the byproduct combustible gas stream to a power generation unit for producing liquefied natural gas (LNG) from natural gas.

In some cases, conveying the byproduct combustible gas stream to a power generation unit further comprises: directing the power produced at the LNG power plant to processing natural gas to natural gas products operations chosen from the group of operations consisting of compression, pumping, blending, separation, operating motors, operating control equipment, and combinations thereof. In some cases, processing natural gas to natural gas products further comprises: producing a carbon dioxide stream; directing the carbon dioxide stream to a natural gas reservoir for stimulating the reservoir; and directing the natural gas from the reservoir to the adjacent facility for producing liquefied natural gas (LNG) from natural gas. In some cases, processing natural gas to natural gas products produces a fire suppression stream comprising carbon dioxide.

In some cases, processing natural gas to natural gas products further comprises: separating acetylene from the first gas stream; and forming a welding gas stream comprising acetylene. In some cases, processing natural gas to natural gas products and producing liquefied natural gas (LNG) from natural gas further comprise: adjusting operations to increase the operation of the adjacent facility to provide more LNG, wherein the LNG production is in response to at least one demand indicator chosen from the group consisting of in anticipation of periods of high LNG demand, in response to high LNG demand, and combinations thereof; and adjusting operations to increase the operation of the first facility to provide more natural gas products in the first facility, wherein the natural gas products are produced in response to at least one demand indicators chosen from the group consisting of in anticipation of periods of high natural gas products demand, in response to high natural gas products demand, and combinations thereof.

In some cases, producing liquefied natural gas (LNG) further comprises producing additional hydrocarbon components selected from the group of hydrocarbon components consisting of ethane, propane, butane, and combinations thereof. In some cases, producing additional hydrocarbon components further comprises separating the additional hydrocarbon components from methane. In some cases, separating the additional hydrocarbon components from methane further comprises utilizing the additional hydrocarbon components for processing natural gas to natural gas products. In some cases, separating the additional hydrocarbon components from methane further comprises separating ethane from the additional hydrocarbon components. In some cases, blending at least a portion of the liquefied natural gas with the first gas stream and forming a transportable and storable mixture further comprise conveying the transportable and storable mixture to a LNG transportation vessel.

In some cases, conveying the transportable and storable mixture to a LNG transportation vessel further comprises providing a vessel capable of transporting blends of LNG with natural gas products. In some cases, conveying the transportable and storable mixture further comprises maintaining thermal regulation. In some cases, forming a transportable and storable mixture further comprises conveying the first gas stream and the LNG to the LNG transportation vessel separately and wherein the LNG transportation vessel is capable of transporting the first gas stream and the LNG separately.

In some cases, the LNG and the first gas stream components are stored in adjacent compartments and wherein at least a portion of one wall of each compartment is shared for enabling heat transfer. In some cases, the vessel that contains the first gas stream components is substantially encompassed by the LNG compartment. In some cases, forming a transportable and storable mixture further comprises: heating the transportable and storable mixture; vaporizing a portion of the first gas stream components to form vaporized first gas stream components in boil-off gases, wherein the vaporized portion has a different molar composition than the transportable and storable mixture.

In some cases, the method further comprises cooling the boil-off to recover a recondensed liquid portion. In some cases, recovering the recondensed liquid portion further comprises enriching the first stream components through one process selected from the group consisting of refrigeration, heat exchange, cryogenic separation, selective absorption, adsorption, phase separation techniques, and combinations thereof. In some cases, redirecting the boil-off gases to any process selected from the group consisting of fuel, heat transfer, reintroduced to the processes, disposal, flaring, venting, and combinations thereof. In some cases, forming a transportable and storable mixture further comprises: introducing the transportable and storable mixture to a vessel; changing the pressure of the vessel; and vaporizing at least a portion of transportable and storable mixture to form boil-off gases, wherein the boil-off gases have a different molar composition than the transportable and storable mixture.

In some cases, the boil-off gases are cooled and at least a portion thereof are recovered as recondensed liquid. In some cases, recovering the recondensed liquid portion further comprises enriching the first stream components through one process selected from the group consisting of refrigeration, heat exchange, cryogenic separation, selective absorption, adsorption, phase separation techniques, and combinations thereof. In some cases, the method further comprises redirecting the boil-off gases to any process chosen from the processes consisting of fuel, heat transfer, reintroduced to the processes, disposal, flaring, venting, and combinations thereof.

In some cases, recovering the recondensed liquid portion further comprises: returning at least a first portion of the recondensed liquid to the vessel; and lowering the temperature of the vessel, wherein lowering the temperature further lowers the vapor pressure of the liquid portion of the transportable and storable mixture. In some cases, recovering the recondensed liquid portion further comprises: returning at least a first portion of the recondensed liquid to the vessel; and lowering the temperature of the liquid portion of the transportable and storable mixture, wherein lowering the temperature further lowers the vapor pressure of the liquid portion of the transportable and storable mixture.

In some cases, forming a transportable and storable mixture further comprises: transporting the mixture to a different location; and separating the mixture to form an LNG stream and a second gas stream comprising the components of the first gas stream. In some cases, separating the mixture comprises a process selected from the group consisting of cryogenic separation, cryogenic distillation, distillation, crystallization, selective absorption, selective adsorption, osmosis, reverse osmosis, methods for separating multi-component mixtures, and combinations thereof.

In some cases, separating the mixture comprises directing the mixture to a separator facility, wherein the separator facility is any facility that is located in a place selected from the group consisting of in, on, near a natural or man-made body of water, on land, and combinations thereof. In some cases, the separator facility further comprises a facility selected from the group consisting of blend transport vessels, free floating structures, ships, barges, platforms, moored vessels, anchored structures, anchored ships, anchored barges, anchored platforms, and combinations thereof. In some cases, the separator facility further comprises a separator facility built at least partially on land.

In some cases, wherein the different location comprises a receiver, configured for processing the transportable and storable mixture, and wherein processing the mixture comprises maintaining the mixture as a phase selected from the group consisting of liquids, cryogenic liquids, slurries, and combinations thereof. In some cases, the different location comprises a receiver configured for storing, processing, and distributing LNG. In some cases, the different location comprises a receiver configured for storing, processing, and distributing the components of the second gas stream.

In some cases, separating the mixture to form an LNG stream and a second gas stream comprising the components of the first gas stream further comprises: heating the mixture, wherein the source of heat for separating consists of a heat source selected from the group consisting of integral heated equipment, integral fired equipment, remote heated equipment, ambient heat from the air, fresh water, sea water, earth, combustion heat from engines, exhaust from combustion engines, compressors, motorized equipment, electrically powered equipment, and combinations thereof; and heating the mixture further comprises re-gasifying at least a portion of the mixture.

In some cases, the different location further comprises a secondary processing unit selected from the group consisting of an air separation unit, an ethylene/ethane separation plant, a differential boil-off re-liquification, a dry-ice processor, a crystallization unit, a cryogenic cooling process, and combinations thereof; and the secondary processing unit is configured for utilizing the cold value of the transportable and storable mixture and the streams separated therefrom.

The cost of producing cryogenically refrigerated liquids is very high. Various operations are listed that require very cold conditions. If the very cold HVG liquid is warmed or vaporized by one or more of these operations, but refrigeration or “cold” nature value of the liquid is utilized directly in place of another means to furnish refrigeration, then the cold value is realized. The cold value of the incoming liquid mixture of LNG and HVG is as large as the refrigeration cost to liquefy the mixture from the original gaseous state of the products.

In some cases, the different location comprises further comprises a cryogenic separation tower for separating the second stream components from LNG. In some cases, the cryogenic separation tower for separating the second stream components from LNG further comprises: operating as a source of cold; and operating the CST re-boiler as a source of heat; wherein the heat source and cold source can be used in a thermodynamic cycle to provide electrical power generation.

In some cases, wherein the cryogenic separation tower for separating the second stream components from LNG further comprises: producing the second stream components in a phase selected from the group consisting of liquids, gases, supercritical fluids, and combinations thereof, and wherein the second stream components phase are pressurized for distribution. In some cases, the method further comprises distributing the second stream components, wherein the distribution means comprises an insulated pipe; and conveying the second stream components to a consumer.

In some cases, separating the mixture to form an LNG stream and a second gas stream comprising the components of the first gas stream further comprises removing a contaminant selected from the group consisting of sulfur, mercury, oxygen, oils, waxes, sand, soil, debris, particulates, and combinations thereof; and wherein removing the contaminant comprises a process selected from the group consisting of inlet filter separators, mist extractors, carbon filters, mol sieves, selective absorbents, and combinations thereof.

In some cases, separating the mixture to form an LNG stream and a second gas stream further comprises: introducing the mixture to a vessel for storage; removing the vapor produced during storage; re-liquefying the vapor produced during storage; and conveying the vapor to a CST. In some cases, conveying the vapor to a CST further comprises introducing the vapor to a vapor inlet of the CST, wherein the vapor composition inside the operating CST at that inlet point more closely compares to the composition of the introduced vapor than the vapor composition inside the CST at the normal feed location.

In some cases, removing the vapor produced during storage further comprises: flashing the transportable and storable mixture in a separator from a high pressure to a low pressure that is higher than, or equivalent to, the operating pressure of the CST at any possible feed location; and producing a lean vapor and an enriched liquid, wherein the lean vapor and enriched liquid are fed to feed locations on the CST, wherein the lean vapor composition is closest to the vapor composition inside the CST at that location, and the enriched liquid composition is closest to the liquid composition inside the CST at the liquid feed location.

In some cases, separating the mixture to form an LNG stream and a second gas stream comprising the components of the first gas stream further comprises heating and gasifying the mixture, wherein the heat of gasification of LNG is partially derived from the condensation of overhead gases in the CST overhead condenser. In some cases, separating the mixture to form an LNG stream and a second gas stream comprising the components of the first gas stream, further comprises: directing a portion of the heat derived from compression of the vapor stream or pumping of the liquid stream of the second gas stream vapor; and conveying the heat through heat exchange to the CST re-boiler.

In some cases, separating the mixture to form an LNG stream and a second gas stream comprising the components of the first gas stream further comprises taking the CST bottoms, wherein the CST bottoms comprise the ethane portion of the LNG. In some cases, taking the CST bottoms further comprises separating the ethane from the remaining components of the CST bottoms stream using a method selected from the group of consisting of cryogenic separation, cryogenic distillation, distillation, crystallization, selective absorption, selective adsorption, osmosis, reverse osmosis, separation of multi-component mixtures, and combinations thereof.

In some cases, the method further comprises substantially removing the ethane portion of the LNG stream from the LNG stream; and conveying the ethane portion to the natural gas conversion process for conversion into hydrocarbon products.

Also disclosed herein is a method for transporting gases, comprising: mixing a first gas stream with a liquid natural gas stream to form a liquid mixture at a first location; transporting the liquid mixture in a vessel to a second location; removing the mixture from the vessel; separating the mixture to form a product gas and liquid natural gas; and recycling the liquid natural gas to the vessel. In some cases, the first gas stream comprises a high value gas. In some cases, the first gas stream comprises at least one gas chosen from the group consisting of ethylene, acetylene, propylene noble gases, hydrogen sulfide, ammonia, phosgene, methyl-ethyl ether, tri-fluorobromoethane, chlorotrifluoromethane, chlorodifluoromethane, di-chloromonofluorormethane, carbon dioxide, carbon monoxide, butene, dibutene, vinyl acetylene, methyl acetylene, water, hydrogen, and combinations thereof. In some cases, the first gas stream comprises a liquefied gas. In some cases, the liquefied gas is in greater proportion than the liquid natural gas in the liquid mixture.

In some cases, mixing the first gas stream with the liquid natural gas further comprises reducing the temperature of the mixture to below the boiling temperature of the liquid natural gas and the liquefied gas in the first gas stream. In some cases, mixing the first gas stream with the liquid natural gas stream further comprises allowing the liquid natural gas to boil. In some cases, allowing the natural gas to boil comprises cooling the first gas. In some cases, transporting the mixture further comprises removing a portion of the mixture for at least one process chosen from the group consisting of fueling a refrigeration system, fueling a transport vehicle, and combination thereof. In some cases, separating the mixture further comprises producing a first gas stream for sale on a market at the second location. In some cases, recycling the liquid natural gas further comprises cooling the vessel during the return trip from the second location to the first location.

Further disclosed herein is a method for transporting gases, comprising mixing a first gas with liquid natural gas at a first location, to form a first liquid-gas mixture; loading a first vessel with the first liquid-gas mixture at the first location; cooling the first vessel by boiling the liquid natural gas; transporting the first vessel to a second location; off-loading the mixture at the second location; separating the mixture into the first gas and the liquid natural gas; and recycling the liquid natural gas to the first vessel.

In some cases, the first gas comprises a component with a market value higher than the market value of liquid natural gas. In some cases, the first gas comprises at least one component chosen from the group consisting of ethylene, acetylene, propylene noble gases, hydrogen sulfide, ammonia, phosgene, methyl-ethyl ether, tri-fluorobromoethane, chlorotrifluoromethane, chlorodifluoromethane, di-chloromonofluorormethane, carbon dioxide, carbon monoxide, butene, dibutene, vinyl acetylene, methyl acetylene, water, hydrogen, and combinations thereof. In some cases, mixing the first gas with liquid natural gas further comprises liquefying the first gas. In some cases, recycling the liquid natural gas to the vessel further comprises pre-cooling the vessel.

In some cases, the method further comprises mixing a second gas with the liquid natural gas, to form a second liquid-gas mixture; loading a second vessel with the second liquid-gas mixture at the second location; cooling the second vessel by boiling the liquid natural gas; transporting the second vessel to a third location; off-loading the mixture at the third location; separating the mixture into the second gas and the liquid natural gas; and recycling the liquid natural gas to the second vessel. In some cases, the second vessel is the first vessel and the third location is the first location. In some cases, the third location comprises a location for selling the second gas. In some cases, recycling the liquid natural gas to the second vessel further comprises cooling the second vessel.

In some cases, separating the mixture further comprises separating the liquid natural gas cryogenically; directing the liquid natural gas to a condenser; and directing the liquid natural gas to the second vessel. In some cases, directing the natural gas to the second vessel further comprises cooling the second vessel. In some cases, cooling the vessel further comprises pre-loading the second vessel with liquid nitrogen.

These and other embodiments, features and advantages will be apparent in the following detailed description and drawings.

### BRIEF DESCRIPTION OF THE DRAWINGS

For a more detailed description of the preferred instance of the present invention, reference will now be made to the accompanying drawings, wherein:

FIG. 1 is a process flow diagram illustrating a gas transport system, according to one embodiment of the disclosure.

FIG. 2 is a process flow diagram illustrating a gas transport system and liquid natural gas cooling system, according to a second embodiment of the disclosure.

FIG. 3 is a process flow diagram illustrating a multi-gas transport system and liquid natural gas cooling system, according to a third embodiment of the disclosure.

FIG. 4 is a process flow diagram illustrating the design and operation of a typical LNG process, according to one embodiment of the disclosure.

FIG. 5 is a process flow diagram illustrating a first design and operation of a gas to multiple product process, according to one embodiment of the disclosure.

FIGS. 6A and 6B depict a process flow diagram illustrating a second design and operation of a LNG production facility alongside a gas to multiple product process, according to a second embodiment of the disclosure.

FIG. 7 is a process flow diagram illustrating liquid natural gas (LNG) and a high value gas (HVG) storage and heat exchange sharing, according to one embodiment of the disclosure.

FIG. 8 is a process flow diagram illustrating recovery of blended boil-off for alternate purposes, according to an embodiment of the disclosure.

FIG. 9 is a process flow diagram illustrating recovery of blended boil-off for alternate purposes, according to an embodiment of the disclosure.

### DETAILED DESCRIPTION OF THE INVENTION

Overview. The present disclosure relates to a process for combining at least one high value gas (HVG) with a liquid natural gas (LNG) stream. The blended gases are refrigerated at a temperature of about the boiling temperature of LNG, or alternatively the condensation temperature of natural gas (NG). The HVG/LNG blend is transported in a vessel by any suitable vehicle. The blended gases are offloaded, and separated into the HVG stream and the liquid natural gas components.

In instances, the HVG is purified and processed according to the local market and demand, while at least a portion of the LNG is returned to the vessel to maintain the temperature of the vessel for the duration of the transit to any loading facility. Non-limiting examples of high value gases include: ethylene, acetylene, propylene, noble gases, hydrogen sulfide, ammonia, phosgene, methyl-ethyl ether, tri-fluorobromoethane, chlorotrifluoromethane, chlorodifluoromethane, di-chloromonofluorormethane, carbon dioxide, carbon monoxide, butene, dibutene, vinyl acetylene, methyl acetylene, water, hydrogen, and combinations thereof. Without limitation, the HVG may comprise a gaseous mixture of two or more high value gases.

The transport of light gases by intimate mixing with LNG may be advantageous when the light gases are more valuable compared to LNG. Also, the light gases may be more easily stored, safer to handle, and/or more easily transported in bulk than the light gases alone. The liquid state of the blend maintains a low temperature suitable for liquefying light gases as well.

The present disclosure also describes improvements to systems for transport of light gases by intimate mixing with liquid natural gas (LNG). In embodiments, the light gases or high value gases (HVG) are mixed with the LNG by any process known to a skilled artisan. A Cryogenic Separation Tower (CST) is one device or system component that can utilize the cold nature of a blend of LNG and HVG to effect a relatively easy and low cost separation of the blend components.

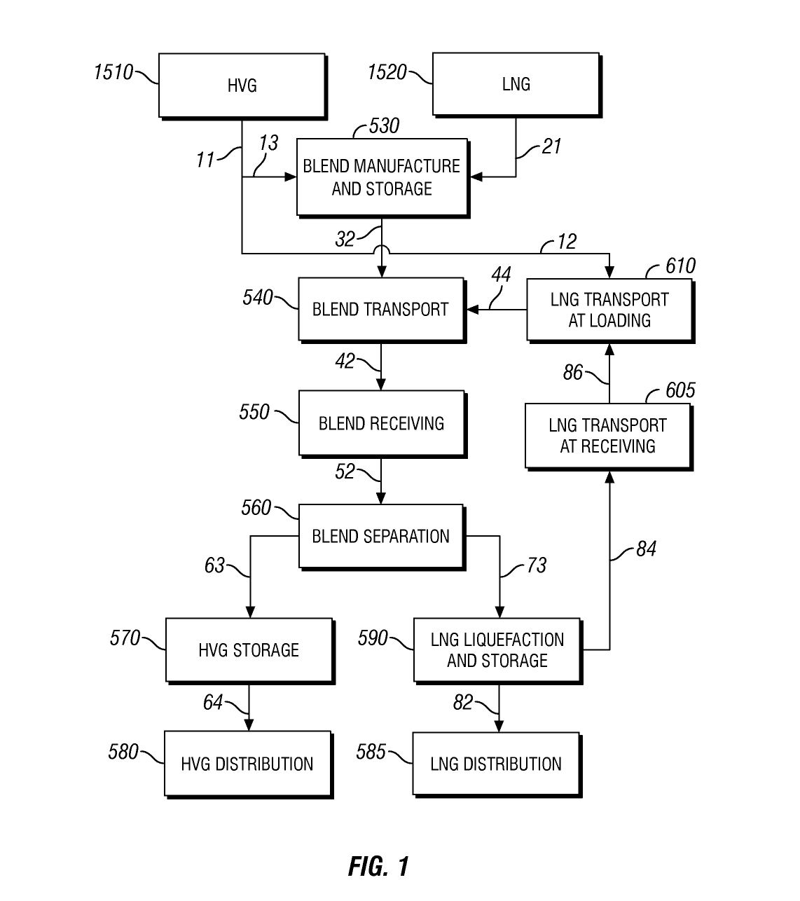

Referring now to FIG. 1, illustrating one embodiment of a process for transporting HVG with LNG: The HVG source 1510 provides HVG stream 11 that is directed to a blending process 530. Additionally, LNG source 1520 provides a LNG stream 21 to the blending process 530. Blending process 530 produces a HVG/LNG blend. Without being limited by theory, the blending process 530 may comprise any process known for blending liquefied gases, including pressurized vessels, refrigeration apparatus, boil-off recyclers, stirrers, and/or pumps, without limitation. In certain instances, the blending process 530 further comprises any apparatus for storage, pressurization, maintenance, and temperature of the HVG/LNG blend for any period of time, without limitation.

The HVG/LNG load stream 32 is directed to the blend transport step 540. The transport step comprises a transport tank or transport vehicle for moving the HVG/LNG blend 42 for long distances. In instances, transport vehicle comprises a storage vessel and apparatus to maintain the HVG/LNG blend at a temperature less than about the boiling temperature of LNG (−260° F./—162° C.). In instances, the boiling point of the HVG/LNG blend may be less than about −100° F. or −73° C. The transport vehicle may be a truck, plane, or a boat. The storage vessel comprises any suitable method for loading/offloading the blends of liquefied gases at multiple locations. The transport step 540 comprises any series of processes designed to maintain the blend until a destination or a receiving site 550 is reached.

In instances, the entire load of blended liquid gases is offloaded at the receiving site 550. The offloaded HVG/LNG stream 52 is directed to blend separation 560. The separation 560 step may comprise any method known to separate at least two liquefied gases with similar boiling temperatures. Non-limiting examples include, but are not limited to distillation, membrane separation, and absorbent separation. Without being limited by theory, the HVG stream 63 and LNG stream 73 are separated into constituent parts, and directed to storage (HVG 570, LNG 590) or to market/distribution (HVG 580, LNG 585) by distribution streams (HVG 64, LNG 82). In further non-limiting examples, when HVG comprises one or more gaseous components, HVG storage 570 and distribution 580 comprise any additional steps known to an artisan for the separation the HVG into its components.

In embodiments, a portion of the LNG is re-liquefied to form stream 84. Stream 84 is returned to a LNG transport 605 at receiving site. In instances, stream 84, comprising a portion of LNG, is returned as stream 86 to the transport vessel as a cooling medium. In instances, the LNG transport 610 is any transport vessel or vehicle, including but not limited to the original transport vessel or another vessel. Transport 610 is any transport returning to LNG source 1520 or HVG source 1510. Alternatively, the LNG from transport 610 used for cooling the vessel is directed to a blend stream 44. The blend stream 44 comprising the LNG is for use in a subsequent blending 540 and transportation 550 processes.

Without being limited by theory, any volume of LNG may be recycled through the blend/transport/vessel cooling cycle as needed. The LNG is reloaded or re-circulated instead of the HVG, because LNG is worth less than the HVG on an equivalent mass or volume basis. The transport vessel is thus maintained at a lower temperature during the return trip and returned to the loading terminal with a minimal amount of LNG already loaded. In certain instances, the LNG used for cooling comprises a pre-load or a pre-mix for the blending process with HVG on subsequent transit phases or trips. When the value of transporting LNG to a receiving terminal is low, but the value of transporting HVG is high, the amount of LNG that is loaded into the vessel is minimized to that which will boil off during transit from loading or originating terminal to the offloading terminal. Alternatively, a quantity of LNG may be re-loaded to the transport vessel at the offloading terminal to maintain temperature during the return or transit back to the point of origin. Further, the LNG used as the cooling charge for the vessel may be used to supplement the fuel for the transit vehicle, reducing fuel costs.

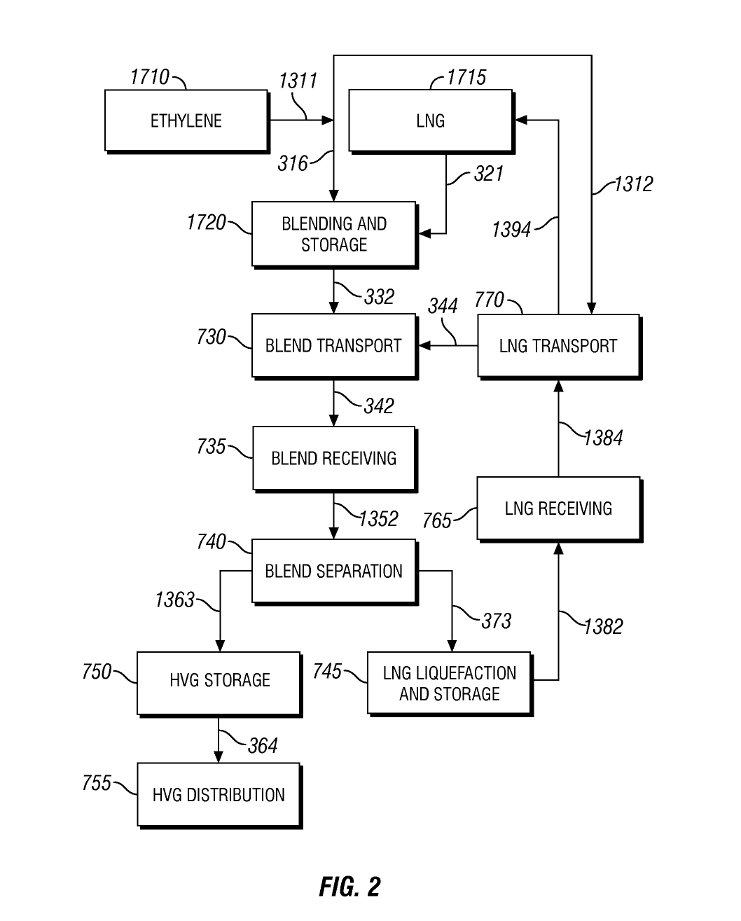

FIG. 2 illustrates an embodiment including the transport of a blend of HVG and LNG whereby the blend is transported from the production or loading site to the receiving or offloading site. At the receiving site, or offloading terminal, the HVG is fully offloaded and distributed. In embodiments, all of the LNG is re-liquefied and returned to the transport vessel for cooling during the return transit or trip of the vessel and/or vehicle.

In embodiments, any HVG, such as ethylene, in non-limiting examples, contained in storage or HVG source 1710 is conveyed as stream 1311 to blending and loading. In embodiments, a first portion 316 of HVG stream 1311 is diverted and directed to the blending process 1720. Blending process 1720 comprises any process as previously described, including storage and maintenance of the HVG in a liquefied state. Further, from HVG stream 1311, a second portion 1312 is sent to a partially filled LNG vessel 770 for transport.

In embodiments, the LNG storage or source 1715 delivers LNG to the blending process 1720 by way of LNG stream 321, as described previously. The HVG/LNG blend produced by blending process 1720 is conveyed as blend stream 332 to blend transport 730. The blend transport 730 is relocated to blend receiving 735 by transit 342. In instances, the blend transport 730 may be any vehicle with a suitable vessel and apparatus for transporting liquefied gases as previously described. In embodiments, the blend transport 730 is a sea-going ship configured for carrying LNG.

At receiving 735, the offload stream 1352 is directed to blend separation 740. The blend separation unit 740 creates a purified HVG stream 1363 and a purified LNG stream 373. HVG/LNG blend is separated by any process known to separate liquids and/or gases. In non-limiting examples, the separation process 740 is a distillation, membrane separation, and absorbent separation process. In instances, the purified HVG stream 1363 is collected in HVG storage unit 750. Stored HVG is conveyed by stream 364 to HVG distribution 755. In further non-limiting examples, when HVG comprises one or more gaseous components, HVG storage 750 and distribution stream 364 comprise any additional steps known to an artisan for the separation the HVG into its components.

Purified LNG stream 373 is conveyed to LNG liquefaction and storage step 745. The stored LNG is returned to the transport vessel 770 via stream 1382 to the LNG receiving process or unit 765, which comprises loading/offloading methods/devices. Without being limited by theory, the LNG receiving process 765 is the reversible process and corresponding apparatus at the destination for the HVG. Then LNG 1384 is reloaded to transport vessel 770. The LNG transport vessel 770 moves, relocates, or transits LNG to the original HVG source location, such as blending site 1720. In embodiments the vessel 770 returns to the original blending site 1720. Upon return to blending site 1720, the LNG vessel may offload a portion of its cargo as return stream 1394 to LNG source or storage 1715. Alternatively, the transport vessel 770 moves to alternate HVG storage, source, or loading sites. In instances, the transport 770 may be moved via 344 in position to become blend transport 730 for further trips to HVG offload site or blend receiving site 735.

Another instance of the embodiment illustrated in FIG. 2, includes loading only enough LNG into a storage container with the HVG such that the HVG/LNG blend comprises substantially more HVG. In this embodiment, the HVG/LNG blend is transported with a minimum of the HVG as boil-off during transport from the loading terminal to the receiving terminal. The blend is then separated into HVG and LNG or NG at the receiving location. While the HVG is offloaded and delivered, the NG is not unloaded to be distributed. Any offloaded natural gas is reloaded into the transport vessel storage container as LNG.

Further, an aspect of the design is a cryogenic separation tower which may utilize nearly total reflux and/or a separate LNG storage container and may be utilized at the receiving terminal for supplying liquid LNG. The LNG that is vaporized may be recondensed by several methods including: heat exchange with vaporizing HVG, compression, and other known refrigeration methods, without limitation. This concept may have increased value if there is no need for natural gas delivery at a location where there is need for HVG delivery. Further, the LNG acts as an in-vessel refrigerant for the return trip, thereby reducing the time to cool the vessel for subsequent HVG transportation, as described hereinabove.

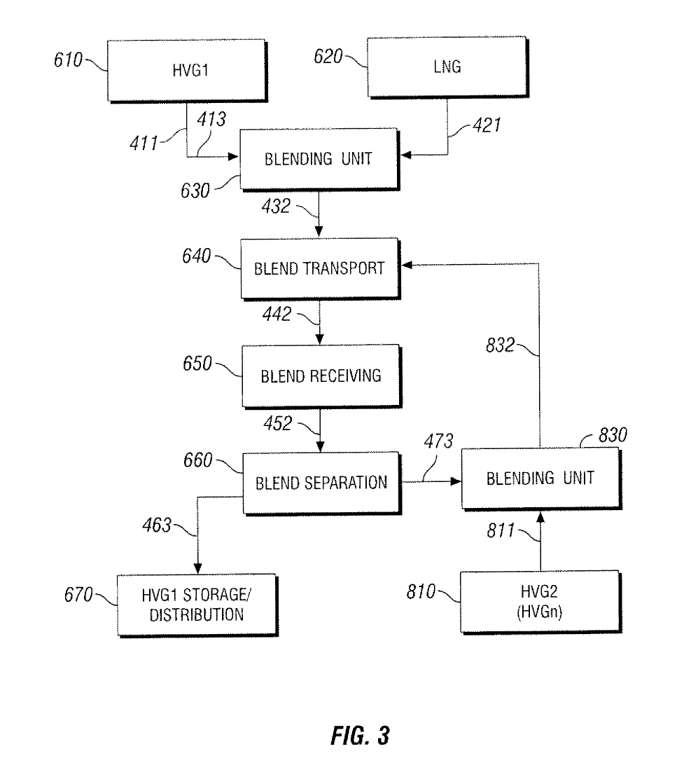

FIG. 3 depicts the transport of a blend of HVG and LNG in two directions. Without limitation, a first HVG, hereinafter HVG1, and LNG blend is transported from the HVG1 production, storage, and/or source site to the receiving site. At the receiving site the HVG1 is fully offloaded for distribution and production. However, the LNG is re-liquefied and returned to the vessel. The vessel partially filled with the LNG, is more completely filled by mass or volume, with a second HVG, hereinafter HVG2. HVG2 is used to make up or fill the vessel to an economically advantageous volume or mass. In non-limiting examples, the vessel is filled with a HVG2/LNG blend or a substantial mass/volume of the HVG2 for return to the HVG1 site. Alternatively, the HVG2/LNG may be conveyed to any number of subsequent sites for the HVGn/LNG blend, wherein HVGn is the n.sup.th high value gas to be transported from location to location sequentially. HVGn represents multiple HVG's that are different from one another in composition or the same. As may be understood, HVGn may include multiple high value gases in any one trip between locations. Also, HVGn may comprise the back and forth transit between two or more offload sites. Further, the LNG may be used to cool the HVGn below boiling temperature, fuel the transport vehicle, and/or provide added value, in instances where LNG has a high market value as a product.

As shown in FIG. 3, HVG1 contained in storage 610 is conveyed as stream 411 where at least as a portion is sent to the blending unit 630, as previously described, by way of stream 413. The LNG from storage or source 620 is conveyed to the blending and loading process 630 by way of LNG stream 421. The HVG1/LNG blend is conveyed as blend stream 432 to transport vessel 640. As also described previously, the transport vessel 640, comprising any known vehicle configured to transport liquefied gases, transits 442 to a receiving location 650. At receiving location 650, the HVG1/LNG stream is offloaded 452 to separation process 660. In instances, separation process 660 directs HVG1 stream 463 to HVG storage and/or distribution 670.

In embodiments, the LNG stream 473, separated from HVG1, is directed to a HVG2 blend process/unit 830. The LNG stream 473 is blended with HVG2 stream 811 from HVG2 source or storage 810. The HVG2/LNG blend stream 832 is directed back to vessel 640 for return to the previous location, in non-limiting examples HVG1 source or storage 610. In instances, HVG2 is any high value gas “n” (HVGn).

Another instance of these embodiments includes a cryogenic separation tower that is utilized to separate the LNG from the HVGn. In instances, the overhead condenser is designed to run at high reflux and form excess liquid LNG. The excess liquid LNG is returned through an insulated line to the transport vessel, keeping the storage container cooler longer. Without being limited by any particular theory, maintaining a cooler vessel during transport of HVGn and/or during return transits reduces the time and cost of refrigerants, turn-around times, and HVGn transportation as a whole.

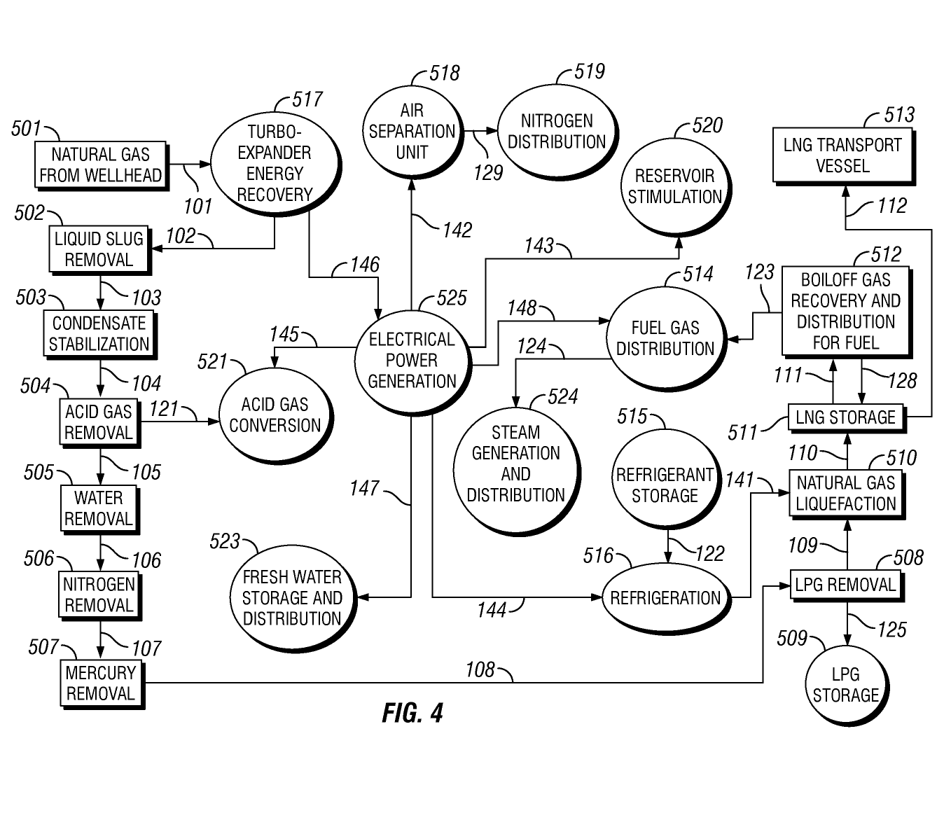

LNG PROCESS: Referring now to FIG. 4, the major gas flow is represented along with major utilities. Produced gas stream 101, available from reservoir 501 at elevated pressure is allowed to pass through turbo-expander 517. Turbo-expander 517 is any device or apparatus that is configured to reduce the pressure of the reservoir 501 through stream 101 in order to recover energy. After passing gas stream 101 through turbo expander 517, a reduced pressure stream 102 is formed.

Reduced gas pressure stream 102 is passed through liquid slug removal device 502. Liquid removal device 502 is any device configured to separate free liquid or a liquid slug from the gas. The separated liquids form saturates stream 103. In certain instances, the gas is a high value gas (HVG). The pressure and temperature of saturated stream 103 is managed in unit 503 to allow the condensate to be removed, which consists of hydrocarbon molecules having four or more carbon atoms. The resulting stream 104 consists mostly of molecules having fewer than four carbon atoms per molecule as well as various contaminants, including water, CO₂ and sulfur containing compounds such as H₂S, mercaptans, mercury containing compounds, sulfides and disulfides. The CO₂ and sulfur containing compounds including H₂S contained in stream 104 is removed in acid gas removal unit 504, forming stream 105.

The water contained in stream 105 is removed in a dehydration unit 505, forming dry stream 106. Dry stream 106 is passed through a unit that removes nitrogen, forming stream 107 which is then treated for mercury content in unit 507. Mercury unit 507 may be a zinc oxide bed or other known apparatus for removing mercury from natural gas, forming stream 108. Stream 108 may be any substantially purified stream of natural gas containing methane and some amounts of ethane, propane and butane.

The propane, butane and heavier hydrocarbons are removed from the gas stream 108 by the LPG removal unit 508 and isolated as liquid petroleum gas in stream 125. Stream 125 is placed in LPG storage 509. The methane and ethane remaining in stream 108 are passed on through LPG processing unit 508 into stream 109. Refrigeration unit 516 cools and liquefies stream 109 in natural gas liquefaction unit 510. The refrigeration unit 516 is supplied by refrigerant stream 122 from refrigerant storage 515. The liquefaction of stream 109 forms LNG stream 110 which is directed to LNG storage 511.

In instances, the air separation unit 518 makes nitrogen stream 129 and conveys it to the nitrogen distribution system 519 for purging equipment.

When needed, e.g., market conditions, transportation, or other predetermined conditions are met, the liquefied gas is extracted from storage 511 as stream 112 and directed to LNG transport vessel 513. Without being limited by theory, during storage, the LNG in storage 511 forms vapor due to heating of the liquid, forming vapor stream 111. Via boiloff gas recovery and distribution unit 512, LNG vapor stream 111 may be re-liquefied and returned to LNG storage 511 as stream 128. Alternatively, the vapor stream 111 may be utilized as fuel gas by being conveyed to fuel gas distribution system 514. Fuel gas is utilized by many energy producers, but notably by the steam generation and distribution system 524. In alternative embodiments, fuel gas is directed to the electrical power distribution system 525 to generate electricity for distribution.

The electrical power generation system 525 makes and distributes power throughout the facility. Most notably the electricity may be distributed as power stream 147 to the fresh water storage and distribution system 523, as power stream 145 to the acid gas conversion unit 521, as power stream 142 to the air separation unit 518, as power stream 144 to the refrigeration unit 516, as power stream 148 to the fuel gas distribution system 514, and as power stream 143 to reservoir stimulation unit 520, without limitation. Further, the electrical power made by the turbo-expander 517 is collected as stream 146 by the electrical power distribution system 525.

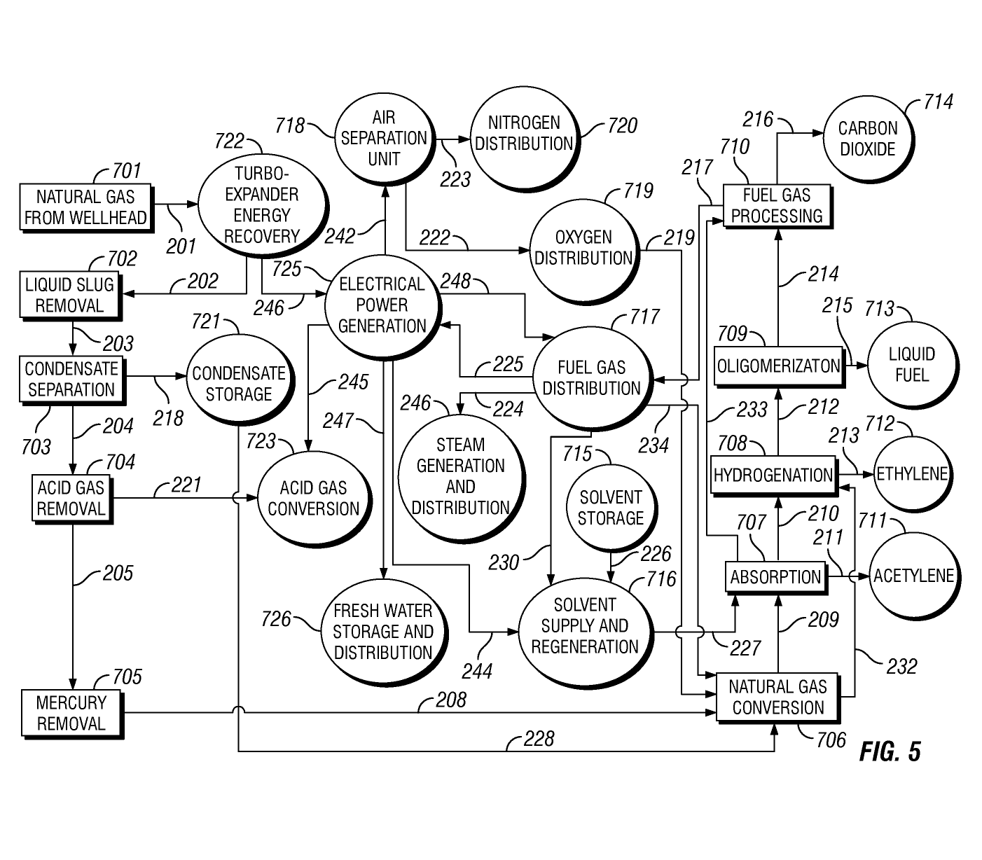

FIG. 5 illustrates an embodiment of the design and operation of a gas to multiple products process (GTX) that may produce acetylene by partial oxidation or pyrolysis of hydrocarbon gases or liquids. The acetylene may be used to produce ethylene by absorption of the acetylene into a liquid and conversion of the acetylene contained in the liquid absorbent through liquid phase hydrogenation. The ethylene produced may be converted to liquids, including liquid fuels, by oligomerization. Gaseous byproducts containing carbon dioxide are separated into a carbon dioxide stream and a second by-product stream. In certain instances, the second by-product stream does not contain carbon dioxide, but may contain hydrogen, methane, carbon monoxide, acetylene and ethylene, without limitation. The carbon dioxide is captured or vented while the fuel gas is used for power or heat production.

As previously described, the produced gas stream available from reservoir 701 at pressure as stream 201 passes through turbo-expander 722. Turbo-expander 722 is any apparatus configured for reducing the stream pressure and recovering the pressure energy. The reduced gas pressure stream 202 is passed through liquid slug removal device 702. The free liquid is separated from the gas by liquid slug removal device 702, thereby forming saturates stream 203. The pressure and temperature of saturated stream 203 is managed in unit 703. The condensate may be removed, in unit 703. In non-limiting examples, the condensate stream 218 produce by unit 703 may comprise hydrocarbon molecules having four or more carbon atoms. Stream 204 from unit 703 comprises molecules having fewer than four carbon atoms per molecule as well as various contaminants, including water, CO₂ and sulfur containing compounds, such as H₂S, mercaptans, mercury containing compounds, sulfides, and disulfides. The CO₂ and sulfur containing compounds, including H₂S, contained in stream 204 are removed in acid gas removal unit 704.

Stream 205 from acid gas removal unit 704 is then treated for mercury content in unit 705. Mercury removal unit 705 may comprise a zinc oxide bed or utilizes other known methods for removing mercury from natural gas, forming stream 208, in a non-limiting example. Stream 208 may also be a substantially purified stream of natural gas and in instances comprises mostly methane with significant amount of ethane, propane and butane. This hydrocarbon stream may be passed to the natural conversion reactor 706, which may comprise one or more of: a pyrolysis reactor, partial oxidation reactor, plasma activated reactor, microwave activated reactor, steam cracking reactor, or other types of reactors, without limitation. In non-limiting examples, the natural conversion reactor 706 is any that is capable of at least partially converting fractions of hydrocarbon gases to reactive products including: acetylene, ethylene, propylene, carbon monoxide, hydrogen, carbon dioxide, vinyl acetylene, methylacetylene, di-acetylene and water, without limitation. A portion of the condensate stream 228 may be directed from condensate storage 721 to the natural gas conversion reactor 706. In embodiments, condensate stream 228 may have additional advantages if the condensate stream has little to no sulfur, mercury, or other contaminants.

In instances wherein the natural gas conversion reactor 706 comprises a pyrolytic or partial oxidation reactor, it may utilize oxygen in stream 219. Oxygen stream 219 may be obtained from the oxygen distribution system 719 as an oxidant capable of producing heat by way of controlled combustion with the hydrocarbons fed to natural gas conversion reactor 706 or with the fuel gas stream 234, or both. In embodiments, a portion of the products of the natural gas conversion reactor 706 are directed as stream 209 to absorption unit 707 wherein acetylene is selectively removed from stream 209. The absorbent is a solvent stored in solvent storage 715 and fed as needed by way of solvent stream 226 to solvent supply and regeneration 716. In instances, fresh absorbent is fed to absorption unit 707 as stream 227 from solvent supply and generation unit 716. The acetylene rich stream 210 formed in the absorption step 707 is conveyed to the hydrogenation reactor where it is reacted with the hydrogen from stream 232 to form ethylene rich stream 212. Directing the natural gas conversion products 232 to hydrogenation reactor 708 utilizes the hydrogen content of stream 232 for the hydrogenation performed in hydrogenation reactor 708.

Alternatively, the acetylene separated from the gas steam 209 by the absorption unit 707 can be transferred to acetylene storage 711 as acetylene rich gas stream 211. Unless all of the acetylene is removed after the absorption step 707 and stored via stream 211 in acetylene storage 711, the remaining portion of the natural gas conversion products are directed to the hydrogenation reactor 708. In hydrogenation reactor/unit 708, the acetylene contained in stream 210 and the hydrogen contained in stream 232 are brought together to form ethylene which can be conveyed to ethylene storage as ethylene rich stream 213 or further conveyed to oligomerization reactor 709 as stream 212.

The oligomerization reactor 709 converts ethylene to larger molecules, including liquids comprising about two-carbon (C2) to about sixteen-carbon (C16) hydrocarbons, e.g., alkenes, aromatics, naphthenes, cyclic compounds and most light compounds characteristic of naphtha, gasoline and jet fuel, in non-limiting examples. The formed liquid fuel is conveyed as stream 215 to liquid fuel storage 713. The remaining gas stream 214 which comprises hydrogen, carbon monoxide, carbon dioxide, unreacted hydrocarbons, acetylene and methane is directed to fuel gas processing 710 where the carbon dioxide is removed as stream 216 and stored in carbon dioxide storage 714.

The fuel gas stream 217, which is stream 214 from which the carbon dioxide containing stream 216 has been removed, is conveyed to fuel gas distribution 717. The fuel gas distribution system 717 distributes fuel gas to solvent supply and regeneration 716 by way of fuel gas stream 230, to the natural gas conversion reactor 706 by way of fuel gas stream 234, and to electrical power generation 725 by way of fuel gas stream 225.

The electrical power generation system 725 makes and distributes power throughout the facility. In embodiments, electrical power generation system supplies electricity as power stream 247 to the fresh water storage and distribution system 726, as power stream 245 to the acid gas conversion unit 723, as power stream 242 to the air separation unit 718, as power stream 248 to the fuel gas distribution system 717 and as power stream 244 to solvent supply and regeneration 716. Power made by the turbo-expander 722 is collected as stream 246 and routed to the electrical power generation system 725.

Further, the air separation unit (ASU) 718 makes nitrogen stream 223 and oxygen stream 222. Stream 223 is conveyed to the nitrogen distribution system 720 for purging equipment. The oxygen stream 222 is conveyed to oxygen distribution 719.

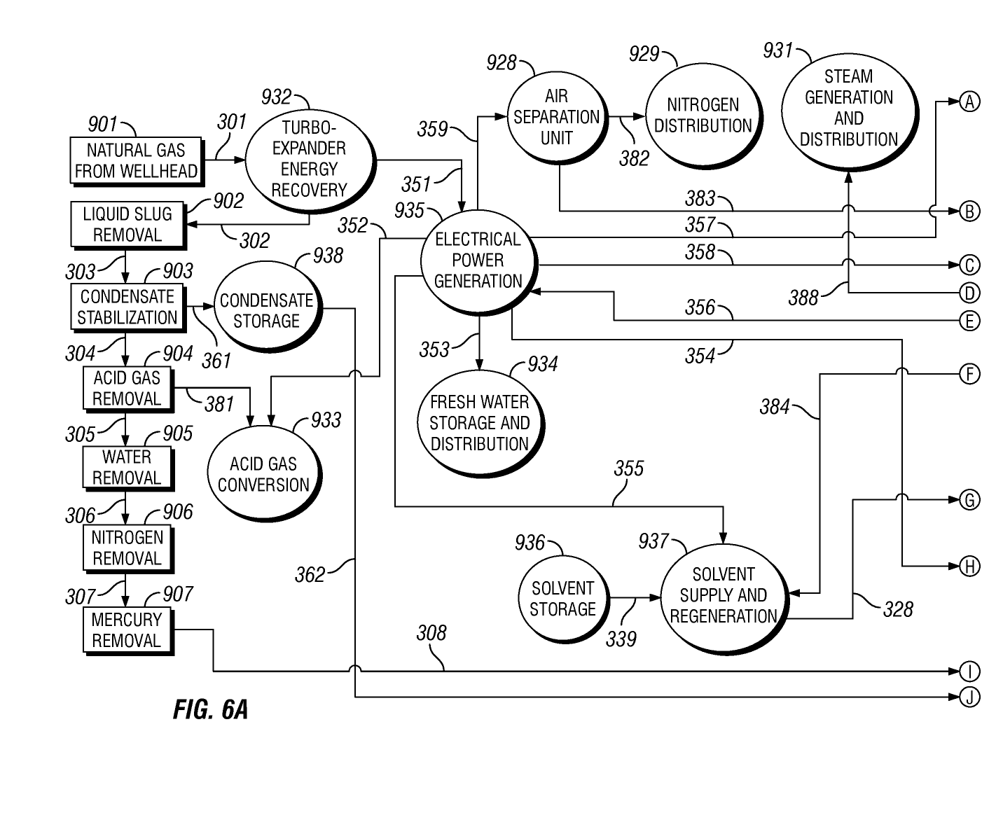

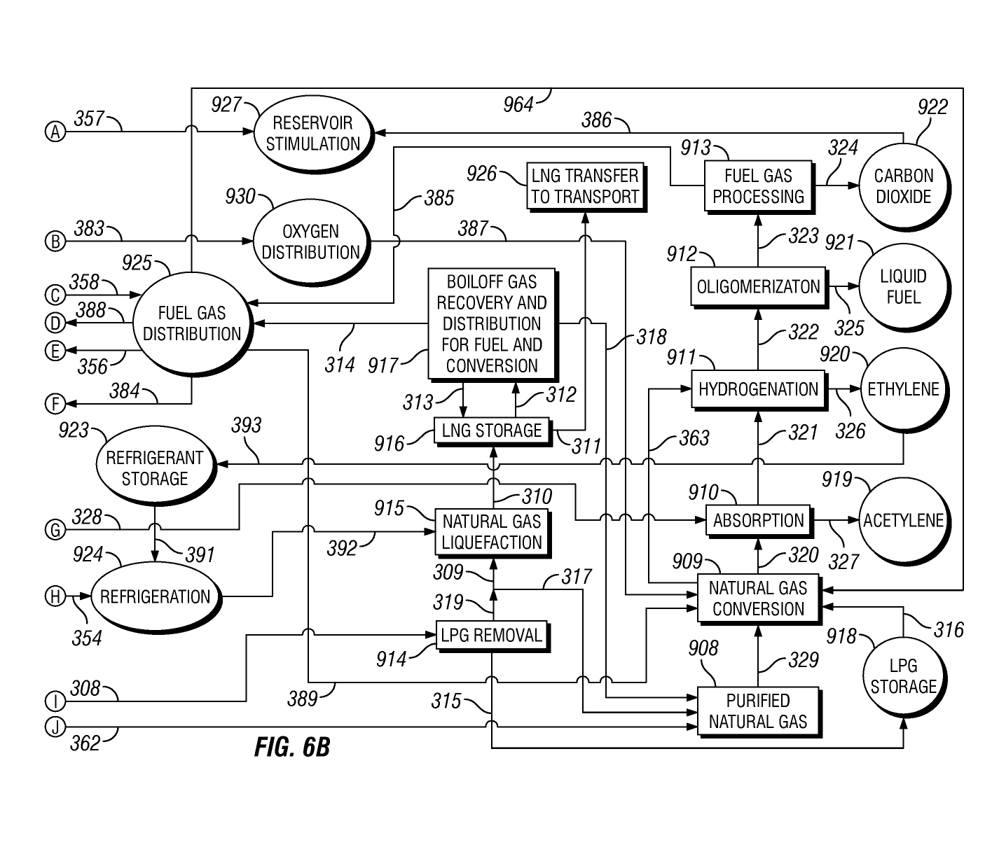

FIGS. 6A and 6B represent the design and operation of a LNG production facility alongside a gas to multiple product process that may produce acetylene by partial oxidation or pyrolysis of hydrocarbon gases or liquid and thereby may produce ethylene by absorption of the acetylene into a liquid and conversion of the acetylene contained in the liquid absorbent through liquid phase hydrogenation. The ethylene produced may be converted to liquids including liquid fuels by oligomerization. Gaseous by-products containing carbon dioxide are separated into a carbon dioxide stream and a carbon-dioxide lean stream. The carbon dioxide lean stream contains substantially no carbon dioxide but may comprise hydrogen, methane, carbon monoxide, acetylene and ethylene. The carbon dioxide is captured or vented while the fuel gas is used for power or heat production. The integration of the two facilities that produce disparate materials from the same raw feed material allows optimization of the design of the utilities, allows for products and byproducts of the natural gas conversion facility to be used in the LNG production facility, allows for more effective sharing of the products of the ASU as the natural gas conversion facility, in some cases, will have a greater need for oxygen and the LNG facility will have a greater need for nitrogen, allows for more effective sharing and optimization of power generation and distribution, allows for utilization of the hydrocarbon byproducts of the LNG production facility as feed hydrocarbon to the natural gas conversion process, and allows for the use of carbon dioxide that may be produced in the natural gas conversion process for reservoir stimulation if desired, without limitation. In addition to these benefits, there is the advantage of being able to blend high value gases produced by the natural gas conversion process with LNG to form a transportable liquid or slurry blend.

Produced gas stream available from reservoir 901 at pressure as stream 301 is allowed to pass through turbo-expander 932 which reduces the stream pressure and recovers pressure energy, as described herein previously. Reduced gas pressure stream 302 is passed through liquid slug removal device 902, which separates free liquid from the gas, forming saturates stream 303. The pressure and temperature of saturated stream 303 is managed in unit 903 to allow the condensate to be removed as stream 361 and stored in condensate storage 938, which often consists of hydrocarbon molecules having 5 or more carbon atoms. The resulting stream 304 consists mostly of molecules having fewer than 5 atoms per molecule as well as various contaminants, including water, CO₂ and sulfur containing compounds such as H₂S, mercaptans, mercury containing compounds, sulfides and disulfides. The CO₂ and sulfur containing compounds including H₂S contained in stream 304 are removed in acid gas removal unit 904, forming stream 305. The acid gases are collected into stream 381 and processed in acid gas conversion system 933.

The water contained in stream 305 is removed in a dehydration unit 905, forming dry stream 306. Dry stream 306 is passed through a unit 906 that removes nitrogen, forming stream 307. Nitrogen free stream 307 is then treated for mercury content in unit 907, which may be a zinc oxide bed or utilizes other known methods for removing mercury from natural gas without limitation, forming stream 308. Mercury free stream 308 is substantially a purified stream of natural gas containing mostly methane. In instances, the mercury free stream 308 may comprise a significant amount of ethane, propane and butane, without limitation. The propane, butane and any remaining heavier hydrocarbons are removed from the gas stream 308 by the LPG process unit 914 and isolated as liquefied petroleum gas (LPG) in stream 315 and placed in LPG storage 918. LPG stream 316 from storage 918 may be passed to natural gas conversion reactor 909. Some methane and ethane contained in stream 308 are passed on through LPG processing into stream 319. Stream 319 is split in some proportion into stream 309 which will be processed by the LNG process unit and stream 317 which will be processed by the natural gas conversion unit.

The refrigeration unit 924, supplied by refrigerant stream 391 from refrigerant storage 923, cools and liquefies stream 309. Refrigerant stream 392 is utilized in natural gas liquefaction unit 915 for forming liquid natural gas stream 310 directed to LNG storage 916. The liquid natural gas is removed from storage 916 in stream 311 and placed in LNG Transport vessel 926. During storage, LNG in LNG storage 916 forms vapor due to ambient or environmental heating of the liquid. Vapor stream 312 may be re-liquefied by boil-off gas recovery and distribution unit 917 for return to LNG storage 916 as stream 313. Alternatively, the boil-off stream 312 may be utilized as fuel gas by conveying gas stream 314 to fuel gas distribution system 925. Alternatively, the boil-off is conveyed to purified natural gas collection unit 908 by way of stream 318.

The electrical power distribution system 935 makes and distributes power throughout the facility. In non-limiting examples, electricity is distributed as power stream 353 to the fresh water storage and distribution system 934, as power stream 352 to the acid gas conversion unit 933, as power stream 359 to the air separation unit 928, as power stream 355 to the solvent supply and regeneration unit 937, as power stream 354 to the refrigeration unit 924, as power stream 358 to the fuel gas distribution system 925, and as power stream 357 to reservoir stimulation unit 927. Power made by the turbo-expander 932 is collected as power stream 351 by the electrical power distribution system 935. Fuel gas collected by the fuel gas distribution system 925 is conveyed in part as stream 356 to electrical power generation unit 935, in part as stream 384 to solvent supply and regeneration 937, and in part as stream 388 to the steam generation and distribution system 931.

In embodiments, the air separation unit 928 makes nitrogen stream 382 and conveys it to the nitrogen distribution system 929 for purging equipment as well as oxygen stream 383 which is conveyed to the oxygen distribution system 930.

Stream 317, which comprises mostly methane and ethane, may be collected in the purified natural gas collection unit 908. Stream 317 or portions thereof are passed as part of stream 329 to the natural gas (NG) conversion reactor 909. The NG conversion reactor may comprise a pyrolysis reactor, partial oxidation reactor, plasma activated reactor, microwave activated reactor, or a steam cracking reactor in non-limiting examples. Further, NG reactor comprises any known reactive methods that are capable of at least partially converting fractions of hydrocarbon gases to reactive products including: acetylene, ethylene, propylene, carbon monoxide, hydrogen, carbon dioxide, vinyl acetylene, methylacetylene, di-acetylene and water, without limitation.

A portion of the condensate stream 362 may be directed from condensate storage 938 to the purified natural gas distribution unit 908. Stream 329 is directed to the natural gas conversion reactor 909, which may be advantageous if the condensate stream has little or no sulfur, mercury, or other contaminants as understood by a skilled artisan. In instances, when NG conversion reactor 909 comprises a pyrolytic or partial oxidation reactor, as illustrated, it may utilize oxygen from stream 387. Oxygen stream 387 obtained from the oxygen distribution system 930 may also be any oxidant capable of producing heat by way of controlled combustion with the hydrocarbons fed to natural gas conversion reactor 909 or with the fuel gas 389, or both. A portion of the products of the natural gas conversion reactor 909 are directed as stream 320 to absorption unit 910. Absorption unit 910 selectively removes the acetylene from stream 320. The absorbent is a solvent absorbent stored in solvent storage 936. Solvent stream 339 is fed to solvent supply and regeneration 937, whereby fresh absorbent stream 328 is fed to absorption unit 910. The acetylene rich stream 321 formed in the absorption step 910 is conveyed to the hydrogenation reactor 911.

Hydrogenation reactor 911 reacts acetylene rich stream 321 with the hydrogen from stream 363 to form ethylene rich stream 322. Alternatively, the acetylene separated from the gas steam 320 by the absorption unit 910 may be transferred to acetylene storage 919 as acetylene rich gas stream 327. Unless all of the acetylene is removed after the absorption step 910 and stored via stream 327 in acetylene storage 919, the remaining portion of the natural gas conversion products are directed to the hydrogenation reactor 911 in order to utilize the hydrogen content of stream 363 for the hydrogenation performed in hydrogenation reactor 911.

In hydrogenation step 911, the acetylene contained in stream 321 and the hydrogen contained in stream 363 are reacted to form ethylene which can be conveyed to ethylene storage 920 by ethylene rich stream 326. Alternatively, the ethylene is conveyed to oligomerization step 912. The oligomerization reactor 912 converts ethylene to larger molecules, including liquids that comprise about two-carbon (C2) to about sixteen-carbon (C16) hydrocarbons, alkenes, aromatics, naphthenes, cyclic compounds and light compounds, e.g., gasoline and jet fuel. The formed liquid fuel is conveyed as stream 325 to liquid fuel storage 921. The remaining gas stream 323 which comprises hydrogen, carbon monoxide, carbon dioxide, unreacted hydrocarbons, acetylene and methane is directed to fuel gas processing 913 where the carbon dioxide is removed as stream 324 and stored in carbon dioxide storage 922.

The fuel gas stream 385, which comprises stream 323 from which the carbon dioxide containing stream 324 has been removed and fuel gas that is not used by the fuel gas processing utility itself is directed to fuel gas distribution 925. The carbon dioxide stored in carbon dioxide storage 922 may be vented, sequestered, or utilized through stream 386 for reservoir stimulation 927. The fuel gas distribution system 925 distributes fuel gas to the natural gas conversion reactor 909 by way of fuel gas stream 389.

### Advantages

Co-Location of the LNG Plant with a Natural Gas Reactive Process (GTX)

There are many unit operations common to both the LNG and GTX plants. Also, the GTX process produces by-products that the LNG process can use as fuel, purge gas or refrigerant. The combined or co-located plant may be designed to take advantage of the following mutual needs more effectively and economically, thereby delivering previously un-contemplated advantages to both processes.

Use of Natural Gas Purified by LNG Pre-Processing in GTX

LNG plants remove such materials as water, nitrogen, CO₂ and sulfur containing compounds such as H₂S, mercaptans, sulfides and disulfides prior to liquefaction of the natural gas. The GTX process is highly sensitive to sulfur content and somewhat sensitive to water, nitrogen and CO₂. Removal of these contaminants is advantageous to the GTX process.

In one embodiment of this disclosure, utilizing the excess capacity of the LNG gas purification system provides gas to a GTX production facility. This reduces the capital and operating cost of the GTX facility. The advantageous combination further includes the fact that separate gas purification equipment is not necessary, while offering the LNG facility a wider product slate and outlet for any excess gas purification capacity.

Another embodiment of this invention is that processed natural gas, from which the sulfur, mercury, nitrogen and/or CO₂ has been removed, is available for HVG implementation. More specifically, the processed natural gas that is ready for subsequent processing to LNG can be diverted to processing by the GTX process into HVGs. This eliminates the need for the GTX process to build a separate facility or facilities to removed sulfur, mercury, nitrogen, or CO₂.

Use of Ethylene Made by GTX in LNG Refrigeration

The ethylene made by the GTX plant can be used as one of a series of refrigerants for the LNG liquefaction process. Using the ethylene may be useful in a cascade cycle. Ethylene is commonly used as a refrigerant in LNG liquefaction, and ethylene would typically not need to be sourced externally for refrigerant makeup. In the present design, storage systems for refrigerants could be much smaller, reducing capital cost.

Nitrogen and Oxygen by Joint Air Separation Unit

LNG plants have an Air Separation Unit (ASU) principally to make nitrogen for purging equipment. A GTX plant may use an ASU for supplying oxygen to the pyrolysis or partial oxidation reactor to enable thermal processing of the natural gas. The nitrogen made by an ASU of the GTX plant could be used as a source of inert purge gas and for refrigerant, particularly, in instances where the LNG plant happens to use nitrogen as a refrigerant. Nitrogen may be used in a cascade refrigerant system or a mixed refrigerant system, without limitation. As such, nitrogen would not need to be sourced externally for refrigerant makeup, and storage systems for refrigerants could be much smaller, reducing capital cost. A joint purpose ASU could provide all of the oxygen needs of the GTX facility, while providing substantial nitrogen needs of the combined site.

Cooling by LNG Turbo-Expander

The LNG turbo-expander (High pressure feed gas) could be used to power the compression of the GTX ethylene so that it cools automatically when passed through an expander. This aids in transfer of ethylene greater distances and in any refrigeration process of gaseous ethylene to liquid ethylene.

Carbon Dioxide Made by GTX for LNG Well Stimulation

The carbon of the natural gas feed for the GTX unit is converted into product, particulate carbon, or CO₂. Much of the CO₂ that is created in the pyrolysis or partial oxidation reactor can be absorbed by a gas sweetening unit and vented at pressure. This CO₂ can be collected for gas sequestration and stimulation of the LNG sourced reservoir at the same time. In embodiments, CO₂ may also be stored as a fire suppressant.

GTX Fuel for the LNG Plant and Localized Power Production

The GTX process can make liquid fuels and produces other combustible gaseous byproducts. Liquid fuels made by the GTX plant can be used to operate various engines for: vehicular transport, localized or mobile power generation, fluid transport (pumps), refrigeration systems, compressors/expanders, and other equipment powered by liquid fuel engines. The GTX process also makes gaseous byproducts that include methane, ethane, carbon monoxide and hydrogen. These gases can be used to provide fuel for the LNG power plant in addition to the GTX reactive process unit. This fuel can be used to return electrical power to the GTX plant. The fuel gases can also be used to heat furnaces for creating steam or for any general gaseous fuel purpose, without limitation. The LNG power generation facility often will be substantially larger than the standalone GTX power production unit. Building one unit will reduce overall capital and operating costs.

Acetylene from the GTX Plant for Construction and Maintenance

The GTX plant may be designed to provide an isolatable acetylene product. The acetylene product can be utilized as a welding gas for purposes of maintenance or construction, in non-limiting examples.

Demand Matching

The combined unit disclosed herein could be designed to produce the maximum LNG or the maximum HVG, such as ethylene without limitation, to best meet profit opportunities. For example, peak energy costs and demand for natural gas for purposes of heating in the winter in North America and Europe counterbalanced by peak ethylene demand for ethylene in summer in China and Japan. The added product flexibility allows for maximum profit from a single resource while maintaining production to full or nearly full capacity all year long.

Removing Ethane from Natural Gas for GTX Processing

As understood by a skilled artisan, the natural gas may contain significant quantities of ethane, the ethane may be separated from the methane at the source and the ethane sent to the GTX plant to convert it into ethylene. This significantly raises the value of the ethane from fuel to chemical stock, all the while having a greater conversion from raw feed material to product or a high yield product in the GTX plant. By substantially removing the ethane from the LNG at the production site, the ethane does not have to be separated therefrom at the receiving terminal.

Use of LPG and Condensate as Feed to GTX

The GTX process can convert LPG and condensate into products though reactive conversion. LPG and condensate are normally considered to be substantially hydrocarbons with three-carbon or more carbons per molecule (C3+). Conversion processes can consist of any known process that can convert C3+ hydrocarbons to compounds comprising olefins and alkynes including acetylene, ethylene, propylene, methyl acetylene, butenes, and other hydrocarbons including naphthenic, saturated cyclic and aromatic hydrocarbons, without limitation. These products of reactive conversion can be HVG's and can be blended with LNG.

Transportation and Storage—Separate Storage of Transportable Gases

Various light gases, including ethylene, propylene, acetylene, various refrigerants, phosgene, hydrogen cyanide, and other compounds and elements that can be transported as a liquid or solid at the boiling point of natural gas can be loaded for transport in a vessel or vessels on a ship or land transport vehicle such that the liquids are not mixed or in direct contact, but are separated by at least one surface. That at least one surface is capable of conducting thermal energy or heat from the higher boiling light gas that is stored as a liquid or solid to the lower boiling natural gas. The system is designed such that as energy is transferred to the higher boiling light gas liquid, the heat can be rejected to the lower boiling natural gas liquid at or near its boiling point, thus maintaining the higher boiling light gas liquid in the previously described solid or liquid state at or near the boiling temperature of the higher boiling natural gas liquid. Heat that is transferred to the lower boiling natural gas liquid causes the boiling of the LNG.

LNG vessels, and particularly marine tanker-ships, are designed to transport LNG in large spherical or membrane tanks. A separate storage compartment could be added to the existing ship, or a new ship design could be implemented. Although any design capable of maintaining the materials separate yet allowing heat transfer through at least one surface is intended by this design, examples of the design include: a vessel holding high boiling liquid (HBL) inside the vessel holding low boiling liquid (LBL), a storage system where the LBL and HBL are separated by one or more common surfaces and the surfaces are vertical, a storage system where the LBL and HBL are separated by one or more common surfaces and the surfaces are horizontal, a storage system where the LBL and HBL are separated by one or more common surfaces and the denser substance is stored below the less dense substance, a system where one storage vessel is a pipe or system of pipes that can hold pressure, without limitation. Such pipes can hold a dual purpose in that they can be evacuated at the receiving terminal and replaced with a heat transfer medium to regulate in-vessel heating of the second fluid that is not contained in pipes. Such media could be nitrogen, natural gas, hydrogen, or other medium that will not liquefy at the temperatures of the LNG.

Generally, the LBL liquid is loaded into the transport vessel first. Sequentially, the HBL is loaded thereafter. Therefore, if the HBL is warmed by the transfer operation, it is re-cooled by the LBL. The LBL boils off, is re-refrigerated and re-loaded. In embodiments, a proper design according to the disclosure would comprise either storage compartment that could be loaded or unloaded in part or completely, independently of the other.

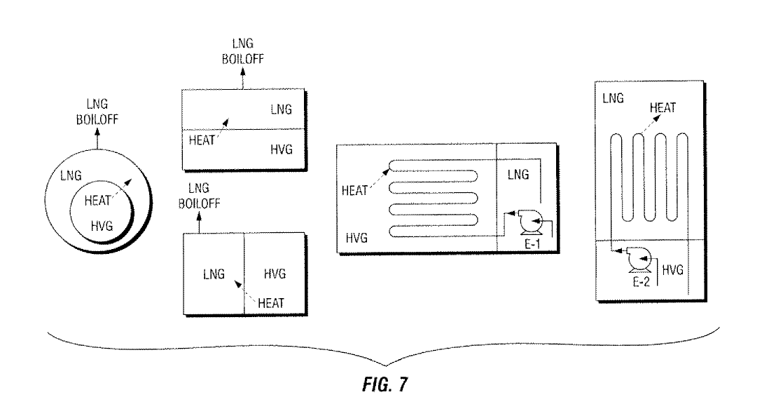

Referring now to FIG. 7, which depicts several embodiments by which LNG and a high value gas (HVG) are stored in chambers whereby they share at least a portion of a heat exchange surface. In each case, the LNG is the HBL and the HVG is the LBL. The purpose of the heat exchange surface is to transfer heat from the LBL to the HBL, preferentially retaining the LBL in the liquid state and allowing the transferred heat to vaporize HBL with the result of maintaining the HBL at the boiling temperature of the LBL. As depicted, the heat transfer surface can be a flat, spherical or complex surface. The method of heat transfer can be active. In non-limiting examples of heat transfer, the heat exchange may be aided by pump assisted flow, such as when heated fluids are pumped into the vessel or passive flow, such as when heat transfer is through a surface. Semi-active heat transfer methods involving percolation, fluid agitation, natural convention, surface condensation, are also employed in certain embodiments.

Boil-Off Recovery

Boil-off gases from storage tanks on land or sea can be re-liquefied or used as fuel. Additionally, land installations can send these into natural gas distribution systems. For HVG blends with LNG, the LNG will often vaporize in greater abundance than the HVG. This is the case for LNG/HVG (e.g. ethylene) blends. Where boil-off will be re-liquefied, modifications to the compressor and heat transfer devices of the re-liquefaction system may be beneficial as the ethylene component may condense out prior to the methane. The process can recapture enriched liquid ethylene separately from the LNG by proper operation. For an existing LNG system, modifications to enable the ethylene to be preferentially and substantially recovered from LNG boil-off include but are not limited to: a re-designed compressor with slightly modified power requirements due to the higher heat capacity and larger heat of vaporization of ethylene, a take-off for liquid that is enriched in ethylene, a separator for separating the liquid stream enriched in ethylene and redesigned or additional heat exchange equipment to handle the different gas mixture and/or the additional ethylene enriched liquid stream.

For situations where the boil-off is normally used for fuel, a small liquid ethylene recovery system may be added to allow liquefaction and recovery of the majority of the ethylene. The ethylene separation thereby allows the majority of the methane to be used as a fuel. This reduced recovery system could consist of a small distillation tower, a compressor with a series of heat exchangers, or other similar equipment useful for separating from natural gas any contained HVG such that the HVG, especially ethylene, can be returned to the storage vessel.

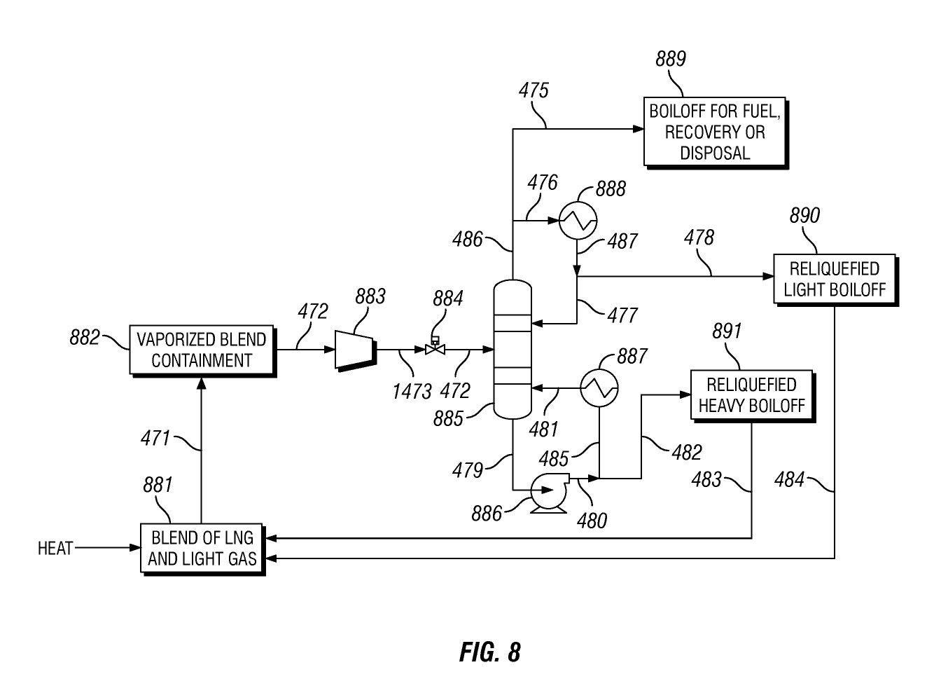

FIG. 8 depicts a process whereby boil-off of a blended material comprised of LNG and a light gas or HVG are recovered or utilized for alternate purposes. In embodiments, the stored blend of LNG and light gas 881 is heated by the environment or a process, directly or indirectly, resulting in formation of a vapor stream 471. Vapor stream may be subsequently processed or portioned by vapor containment unit 882. In instances, a portion of this vapor stream 471 may be conveyed as stream 472 to compressor 883. Compressor 883 increases the stream pressure for further processing into pressurized stream 1473. The flow of pressurized stream 1473 is controlled by valve 884, forming inlet feed stream 472 to distillation tower 885 which is at a lower pressure than stream 1473. The distillation tower 885 comprises a separation device having the ability of a partial theoretical tray of separation to multiple theoretical trays of separation. The distillation tower bottoms stream 479 is moved by pump 886 forming higher pressure stream 480. A portion of stream 480 is conveyed as stream 485 through re-boiler 887 which heats stream 485 forming stream 481 which is conveyed back to column 885. A portion of stream 480 is removed and conveyed as stream 482 to re-liquefied heavy boil-off storage 891 which is optionally conveyed in part to blend storage 881 as stream 483. The distillation tower tops stream 486 is conveyed in part as stream 475 to boil-off distribution for fuel, recovery or disposal in unit 889. The distillation tower tops stream 486 is conveyed in part as stream 476 through condenser 888 forming cooled tops stream 487. A portion of cooled tops stream 487 is returned as reflux to distillation tower 885 as reflux stream 477. Another portion of cooled tops stream 487 is conveyed as stream 478 to re-liquefied light boil-off collection 890. A portion of the re-liquefied light boil-off may be conveyed as stream 484 to blend storage 881.

Using Boil-Off to Remediate Environmental Pressure Events

Storage tanks undergo infrequent large environmental pressure changes due to weather fronts or various forms of precipitation resulting in excess or abnormal boil-off. Re-liquefaction facilities can return excess boil-off to these storage tanks. When the boil-off of a blend leads to the potential capture and return of different liquid streams, it is possible to return one or the other stream to provide some control on the boil-off rate. For example, one component of the blend will boil at a different temperature than the other component.

In the non-limiting example of methane and ethylene, the boiling temperature of methane is much lower than that of ethylene. The mixture boiling temperature will be somewhere in between those two boiling points. During a low pressure environmental event, colder liquid methane may be returned to the storage tank while the higher temperature liquid ethylene may be stored elsewhere. Alternatively, the liquid ethylene may be sent to ethylene distribution or added to the cryogenic separation system (CST).

In embodiments, the colder methane will lower the temperature of the mixture, controlling the excess boil-off. The addition of the liquid methane must reduce the temperature enough to overcome the lowering of the boiling temperature of the new blend. Without being limited by theory, the new blend will have a lower boiling point than the original mixture due to the introduction of a lower boiling component. Alternatively, liquid ethylene may be sub-cooled to the temperature of liquid methane by heat exchange with liquid methane before being added to the mixture. The addition of ethylene to the mixture lowers the temperature of the mixture, and simultaneously increases the boiling point of the mixture. The disclosed process may accomplish this by addition of an additional refrigeration device and/or a heat exchanger that would vaporize liquid methane while sub-cooling the ethylene.

Novel CST Locations

The cryogenic separation system (CST) that provides for separation of HVG from LNG may be built and installed on each vessel, transfer ship, or built on a floating platform. Such installations may be preferable when conventional facilities cannot be constructed onshore or because gas storage caverns already exist. Using the ship as the only liquid storage device eliminates the need to deliver the liquid blend in liquid form to an onshore facility and eliminates the need for and cost of an onshore storage facility.

Receiving Terminal Improvements

Combine Peak Demand LNG Facilities with Ethylene Peak Demand

There are many re-gasification plants that operate only a few days a year. They are built to accumulate and store LNG the rest of the year. The cost/benefit of many of these installations is questionable or unclear for many processes. In embodiments, the cost/benefit may be improved by adding liquid ethylene storage facilities alongside the LNG facilities. Normally, peak ethylene demand is in the summer. As such, the current disclosure increases the overall profitability of these installations that operate periodically. In one embodiment, these installations would be sourced most easily by LNG or LNG/HVG blend transport ships including a CST. In another embodiment, building a CST on a mobile platform or barge would provide similar service flexibility and advantages.

Any Source of Heat for CST or Re-Gasification

Any standard source of heat can be used for re-gasification and/or operation of the CST for separation of the blend or the fractions thereof. Non-limiting examples, include: integral-heated (fired), remote heated (fired), ambient heated (water, air, geothermal) and process heated re-gasification processes. This also includes combustion heat from engines, compressors and other motorized or powered equipment, without limitation.

Improved Cold Sources

Other plants that require cold sources can be sited at the blend separation and re-gasification facility. The CST furnishes cold methane gas and cold liquid ethylene, which carries more “cold” energy. Matching of independent facilities to the temperatures of these products can lead to savings for both independent plants. Non-limiting examples of cold value for the proposed site include: pre-cooling or intercooling the feed to ethylene or methane compressors. The cold sources further have uses for increasing compressor efficiency and pre-cooling air for an ASU or liquid air plant. Cooling the air to a co-located power plant improves power plant efficiency as well as provides waste heat from gas vaporization. There are many chemical processes that would benefit from having a source of cold to reject heat to. The added advantage of this site where cold and ethylene are available is a source of ethylene that can be used as a refrigerant. Some of this available cold, especially the very cold methane overhead vapor can be used for boil-off re-liquefaction because, if operated at a similar pressure to the storage, the methane vapor and overhead condenser liquid will be colder than the stored blended liquid. In one embodiment, using the CST re-boiler as a source of cold, air or water as a source of heat, an electrical generation power plant may be developed wherein the ethylene or other HVG, such as propylene, serves as the “steam” and is operated according to electrical power plant methodology based on steam principles.

Conveying Cryogenic Ethylene to a Distant Ethylene Distribution System

To lower cost of adding pipeline from the production source of ethylene, representative of an HVG, at the CST to a distant ethylene distribution system, it is possible to build a relatively small insulated pipeline to carry liquid to a gasification site near the pipeline where the tie-in would be made. For example, a 10 inch line with 2 inch insulation could carry about 200 MMSCFD of ethylene gas from 25 miles to 100 miles. This assumes the liquid is cooled to its normal boiling point at atmospheric pressure and warms to near its actual boiling point at pressure at the destination. This would replace a 30 inch gas line operated at delivery pressure. Alternatively, if delivered above its critical pressure (742 psia), ethylene can be delivered at ambient temperature without risk of having a two-phase fluid.

Gas Cleanup at Receiving Terminal

Natural gas contains contaminants such as odorants, moisture, dusts, and particulates that were part of the LNG during blending or were formed during transfer on or off ship or during transport will need to be removed from the blend prior to or after separation at the cryogenic separation facility at the receiving terminal. All normal methods to remove contaminants, such as mol sieves, activated carbon, gas sweetening, without limitation, may be utilized. Dust, oils, heavy hydrocarbons, may be removed with inlet filter separators, mist extractors, and/or carbon filters, without limitation. Any CO₂ treatment chemicals present, such as glycols or amines or methanol need to be removable as well by proven methods.

### CST Design Improvements

Separate Vapor Inlet

As liquid blend is pumped to the cryogenic separation tower, some of the liquid may be vaporized prior to reaching the pump. Under normal conditions, the remaining pumped liquid will be sub-cooled prior to introduction to the cryogenic separation tower (CST). The low pressure vapor may be collected and compressed and optionally cooled such that it can be introduced to the CST. Because methane is more volatile than ethylene and many other HVG's, the vapor may have a composition different from that of the pumped liquid. It will be advantageous to have a vapor inlet port to the CST at a higher theoretical tray such that the vapor on that tray will have a composition that compares more exactly to the inlet vapor composition. In embodiments, these modifications will enhance separability in the CST.

Pre-Separator for Flashed Liquid

The pumped liquid will be introduced at a higher pressure than the operating pressure of the CST at the introduction point and possibly at a higher pressure than anywhere in the CST. When the pumped liquid pressure is reduced, to prevent or reduce foaming, pressure reduction may be done within a gas-liquid separation vessel mounted on the tower. The liquid and gas may then enter the CST at the same stage or separate stages, depending on the compositions of the liquid and gas streams. Optimum separation will generally occur at lower pressures, but design and cost issues may suggest preferred operating conditions at a higher pressure and especially between atmospheric pressure and the operating pressure of either distribution pipeline and more preferentially between ambient pressure and the pressure of the lower pressure distribution system (i.e. ethylene or natural gas).

Use Sea Water for Cheap Ethylene Vaporization

The lower cost of sea water sourced gas vaporization compared to air sourced gas vaporization may suggest that on-shore cold liquid ethylene be sent off-shore to specially designed sea water heaters before the gas is conveyed to an onshore distribution line. The liquid ethylene coming from the CST would first be pumped to a high pressure at or above that of the distribution line. The liquid would then be conveyed to the sea-water vaporizer and vaporized. From there, the high pressure gas would be conveyed to the ethylene distribution line. If the CST were platform or ship mounted, ethylene vaporization could be integrated into the structure or transport ship since sea water would be nearby and plentiful.

Integrated Condenser/Re-Boiler Design for Better Efficiency

The process of ethylene vaporization may be coupled through heat exchange with the refrigeration process of the CST required for reflux production from overheads, lowering the operating cost of the overhead condenser.

Ethane/Ethylene Separation

Because natural gas may contain significant quantities of ethane, it may be advisable or necessary to separate ethane from the ethylene at the delivery site. In this case, an ethane/ethylene splitter or separator will have to be added to the CST. A cold separation of liquid ethane and ethylene is facilitated by the widely different normal boiling points of these two compounds. Ethane boils at −127 F and the boiling point of ethylene is −154 F at normal conditions.

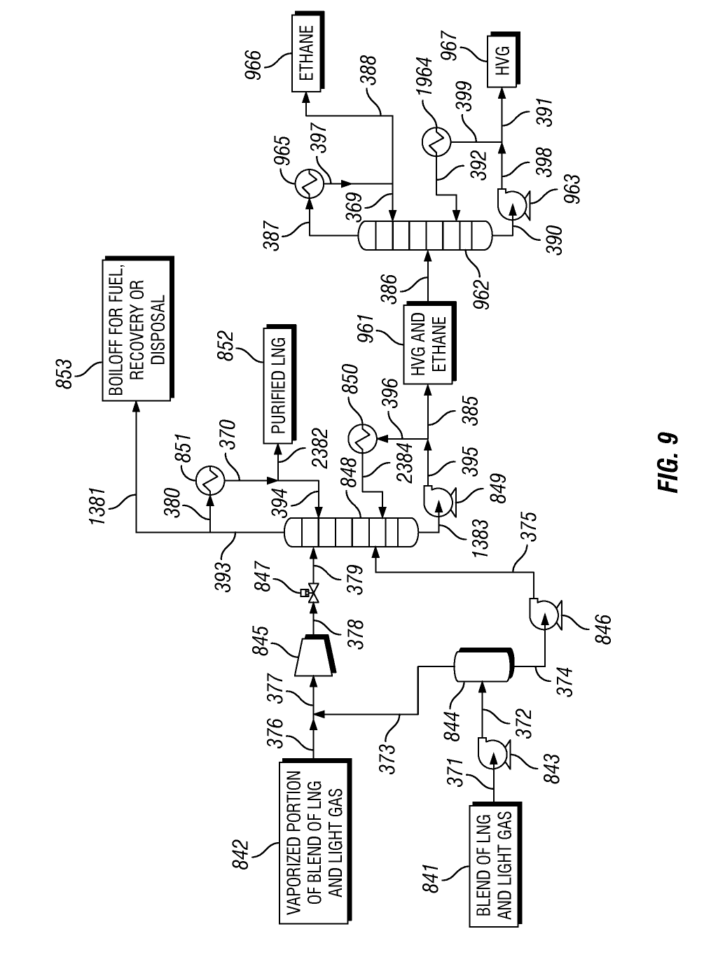

For example, FIG. 9 depicts a process whereby boil-off of a blended material comprised of LNG and a light gas or HVG are recovered or utilized for alternate purposes and ethane, when present, is separated from the HVG where liquid blend of LNG and HVG is also charged to a distillation tower such that the liquid blend and boil-off vapors are optionally both feeds to a distillation tower and ethane, when present, is separated from the HVG.

The stored blend of LNG and light gas 841 is conveyed as a liquid as stream 371 to pump 843 which conveys the enhanced pressure stream 371 as stream 372 to flash separator 844. The vapor from flash separator 844 is conveyed as vapor stream 373 that can be mixed with vapor stream 376 which derives from boil-off of LNG or a blend of LNG and light gases storage unit 842. These vapor streams 373 and 376 are combined into stream 377 and optionally compressed by compressor 845 producing a higher pressure vapor stream 378, which may be conveyed through a valve 847 for controlled flow of the resulting stream 379 into distillation tower 848. The distillation tower bottoms stream 1383 is moved by pump 849 forming higher pressure stream 395. A portion of stream 395 is conveyed as stream 396 through re-boiler 850 which heats stream 396 forming stream 2384 which is conveyed back to distillation column or tower 848. A portion of stream 395 is removed and conveyed as stream 385 to HVG and ethane containment 961. The distillation tower tops stream 393 is conveyed in part as stream 1381 to boil-off distribution for fuel, recovery or disposal in unit 853. The distillation tower tops stream 393 is conveyed in part as stream 380 through condenser 851 forming cooled tops stream 370. A portion of cooled tops stream 370 is returned as reflux to distillation tower 848 as reflux stream 394, while another portion of cooled tops stream 370 is conveyed as stream 2382 to purified LNG containment 852.

HVG and ethane contained in HVG and ethane containment 961 is conveyed as stream 386 to distillation tower 962. The distillation tower bottoms 390 is moved and pressurized by pump 963 forming pressurized stream 398. A portion of stream 398 is conveyed as stream 399 through re-boiler 1964. Re-boiler 1964 heats stream 399 forming stream 392, which is conveyed back to distillation tower/column 962. A portion of stream 398 is removed and conveyed as stream 391 to HVG storage 967.

The distillation tower tops stream is conveyed as stream 387 through condenser 965 forming cooled tops stream 397. A portion of stream 397 is returned as reflux to distillation tower 962 as stream 369 while another portion of stream 397 is conveyed as stream 388 to ethane storage 966.

While particular aspects of the present invention have been described herein with particularity, it is well understood that those of ordinary skill in the art may make modifications hereto yet still be within the scope of the present claims. The invention is in no way limited to the particular embodiments disclosed herein.

What is claimed is:

1. A method for transporting gases, comprising:
mixing a first gas stream with a liquid natural gas stream to form a liquid mixture at a first location;
transporting the liquid mixture in a vessel to a second location;
removing the liquid mixture from the vessel;
separating the liquid mixture to form a product gas and liquid natural gas; and
recycling the liquid natural gas to the vessel.

2. The method of claim 1, wherein the first gas stream comprises a high value gas.

3. The method of claim 2, wherein the first gas stream comprises at least one gas selected from the group consisting of ethylene, acetylene, propylene noble gases, hydrogen sulfide, ammonia, phosgene, methyl-ethyl ether, tri-fluorobromoethane, chlorotrifluoromethane, chlorodifluoromethane, di-chloromonofluorormethane, carbon dioxide, carbon monoxide, butene, dibutene, vinyl acetylene, methyl acetylene, water, hydrogen, and combinations thereof.

4. The method of claim 1, wherein the first gas stream comprises a liquefied gas.

5. The method of claim 4, wherein the liquefied gas is in greater proportion than the liquid natural gas in the liquid mixture.

6. The method of claim 1, wherein mixing the first gas stream with the liquid natural gas stream further comprises reducing the temperature of the liquid mixture to below a boiling temperature of the liquid natural gas stream and a liquefied gas in the first gas stream.

7. The method of claim 1, wherein mixing the first gas stream with the liquid natural gas stream further comprises allowing liquid natural gas in the liquid natural gas stream to boil.

8. The method of claim 7, wherein allowing the liquid natural gas to boil comprises cooling the first gas stream.

9. The method of claim 1, wherein transporting the liquid mixture further comprises removing a portion of the liquid mixture for at least one process selected from the group consisting of fueling a refrigeration system, fueling a transport vehicle, and combination thereof.

10. The method of claim 1, wherein separating the liquid mixture further comprises producing a second gas stream for sale on a market at the second location.

11. The method of claim 1, wherein recycling the liquid natural gas further comprises cooling the vessel during the return trip from the second location to the first location.

12. A method for transporting gases, comprising:
mixing a first gas with liquid natural gas at a first location, to form a first liquid-gas mixture;
loading a first vessel with the first liquid-gas mixture at the first location;
cooling the first vessel by boiling the liquid natural gas;
transporting the first vessel to a second location;
off-loading the first liquid-gas mixture at the second location;
separating the first liquid-gas mixture into the first gas and the liquid natural gas; and
recycling the liquid natural gas to the first vessel.

13. The method of claim 12, wherein the first gas comprises a component with a market value higher than a market value of liquid natural gas.

14. The method of claim 12, wherein the first gas comprises at least one component selected from the group consisting of ethylene, acetylene, propylene noble gases, hydrogen sulfide, ammonia, phosgene, methyl-ethyl ether, tri-fluorobromoethane, chlorotrifluoromethane, chlorodifluoromethane, di-chloromonofluorormethane, carbon dioxide, carbon monoxide, butene, dibutene, vinyl acetylene, methyl acetylene, water, hydrogen, and combinations thereof.

15. The method of claim 12, wherein mixing the first gas with the liquid natural gas further comprises liquefying the first gas.

16. The method of claim 12, wherein recycling the liquid natural gas to the vessel further comprises pre-cooling the vessel.

17. The method of claim 12, further comprising:
mixing a second gas with the liquid natural gas to form a second liquid-gas mixture;
loading a second vessel with the second liquid-gas mixture at the second location;
cooling the second vessel by boiling the liquid natural gas;
transporting the second vessel to a third location;
off-loading the second liquid-gas mixture at the third location;
separating the second liquid-gas mixture into the second gas and the liquid natural gas; and
recycling the liquid natural gas to the second vessel.

18. The method of claim 17, wherein recycling the liquid natural gas to the second vessel further comprises cooling the second vessel.

19. The method of claim 17, wherein separating the second liquid-gas mixture further comprises:
separating the liquid natural gas cryogenically;
directing the liquid natural gas to a condenser; and
directing the liquid natural gas to the second vessel.

20. The method of claim 19, wherein directing the natural gas to the second vessel further comprises cooling the second vessel.
